(19) United States
(12) Patent Application Publication
(10) Pub. No.: US 2012/0132544 A1
(43) Pub. Date: May 31, 2012

(54) ELECTROCHEMICAL SENSOR

(75) Inventors: Nathan Lawrence, Cambridge (GB); Andrew Meredith, Cambridge (GB)

(73) Assignee: Schlumberger Technology Corporation, Cambridge, MA (US)

(21) Appl. No.: 13/204,166

(22) Filed: Aug. 5, 2011

Related U.S. Application Data
(60) Provisional application No. 61/371,472, filed on Aug. 6, 2010.

(51) Int. Cl. G01N 27/26; G01N 27/30

(52) U.S. Cl. 205/782; 204/412; 204/290.01

(57) ABSTRACT

An electrochemical sensor for measuring an analyte in a fluid, the electrochemical sensor having a first working electrode that includes a redox species sensitive to the analyte to be measured and a second working electrode made from a conducting substrate absent the redox species. The electrochemical sensor being capable of operation so that electrochemical effects of active contaminants in the fluid can be removed/attenuated from electrochemical signals produced by the reduction/oxidation of the redox species in the presence of the analyte.

### CROSS REFERENCE TO RELATED APPLICATIONS

This application is a non provisional patent application from U.S. Provisional Application No. 61/371,472 filed Aug. 6, 2010 and is incorporated by reference herein in its entirety.

### BACKGROUND

Embodiments of the present invention relate to an electrochemical sensor for detecting and monitoring analytes. More specifically, but not by way of limitation, certain embodiments of the present invention provide methods of operating an electrochemical sensor to and an electrochemical sensor for, among other things, determining pH and analyzing ion content of fluids. In other embodiments, the electrochemical sensor and methods may be used to detect and measure analytes such as hydrogen sulphide, oxygen, carbon dioxide, nitrates and/or the like.

The detection and/or measurement of analyte concentration, for example particular hydrogen ion concentration or pH, are important, in a number of research, industrial, and manufacturing processes. Merely way of example, pH measurement is important in the pharmaceutical industry, the food and beverage industry, the treatment and management of water and waste, chemical and biological research, hydrocarbon production, water monitoring and/or the like. Moreover, there has been a long felt need across numerous industries for better analyte sensing techniques, including pH detection.

In the hydrocarbon industry, analysis operations may obtain an analysis of downhole fluids usually through wireline logging using a formation tester such as the MDT™ tool of Schlumberger Oilfield Services. However, more recently, it was suggested to analyze downhole fluids either through sensors permanently or quasi-permanently installed in a wellbore or through sensors mounted on the drillstring. The latter method, if successfully implemented, has the advantage of obtaining data while drilling, whereas the former installation could be part of a control system for wellbores and hydrocarbon production therefrom.

To obtain an estimate of the composition of downhole fluids, the MDT tools may use an optical probe to estimate the amount of hydrocarbons in the samples collected from the formation. Other sensors use resistivity measurements to discern various components of the formations fluids.

Particularly, knowledge of downhole formation (produced) water chemistry is needed to save costs and increase production at all stages of oil and gas exploration and production. Knowledge of particularly the water chemistry is important for a number of key processes of the hydrocarbon production, including:
Prediction and assessment of mineral scale and corrosion;
Strategy for oil/water separation and water re-injection;
Understanding of reservoir compartmentalization/flow units;
Characterization of water break-through;
Derivation of the water cut R_{w}; and
Evaluation of downhole the H₂S partition the oil and or water (if used for H₂S measurements).

Some chemical species dissolved in water (including, for example, Cl⁻ and Na⁺) do not change their concentration when removed to the surface either as a part of a flow through a well, or as a sample taken downhole. Consequently information about their quantities may be obtained from downhole samples and in some cases surface samples of a flow. However, the state of chemical species, such as H⁺ (pH=−log [concentration of H⁺]), CO₂, or H₂S may change significantly while tripping to the surface. The change occurs mainly due to a difference in temperature and pressure between downhole and surface environment. In case of sampling, this change may also happen due to degassing of a sample (seal failure), mineral precipitation in a sampling bottle, and (especially in case of H₂S)—a chemical reaction with the sampling chamber. It should be stressed that pH, H₂S, or CO₂ are among the most critical parameters for corrosion and scale assessment. Consequently it is of considerable importance to know their downhole values precisely.

The concentration of protons or its logarithm pH can be regarded as the most critical parameter in water chemistry. It determines the rate of many important chemical reactions as well as the solubility of chemical compounds in water, and (by extension) in hydrocarbon.

Analyzing samples representative of downhole fluids is an important aspect of determining the quality and economic value of a hydrocarbon formation. Similarly, analyzing properties of liquids associated with an aquifer may be important in aquifer analysis in the hydrocarbon, water production industries and/or resource management.

Electrochemical sensors using redox active species, while having advantages over potentiometric sensors, may themselves have operability issues. For example, in the food and beverage industry, water treatment/management and/or the biotech industry, it may not be desirable or even allowable in accordance with regulations to have the redox active species leech/diffuse from the electrochemical sensor. Moreover, handing of sensors comprising certain redox species may be an issue. Further, leeching/removal of the redox species from the sensor may affect performance of the sensor. In addition, it may be difficult/costly to fabricate an electrochemical sensor comprising redox species. Another issue is that electrochemical sensors using microelectrode designs may be easily fouled etc. and/or may have fabrication and/or operation issues.

Additionally, operation of electrochemical sensors using redox species may be problematic in the presence of active compounds, which producing noise in voltammetric/amperomteric measurements produced by the sensor; where the noise may obscure the desired data. In operation, the voltammetric/amperometric response of an electrochemical sensor using redox active species may be submerged by voltammetric/amperometric effects produced by active species in a fluid being analyzed/measured. As such, the redox based electrochemical sensor may not be able to provide meaningful and/or accurate measurements.

Hence, there is and will continue to be a demand for redox-type electrochemical sensors that, among other things, do not leech/diffuse from the substrate(s)/electrode(s) of the electrochemical sensor, can be easily/efficiently fabricated, are safe to handle, do not include detrimental factors associated with microelectrode design and/or the like and produce data with reduced noise or that can be processed to identify the desired data.

The present invention provides an apparatus and method for performing electrochemical measurements. More specifically, the present invention provides a robust/efficient electrochemical sensor for accurate ion selective electrochemical measurements, including pH measurements.

### SUMMARY

Embodiments of the present invention provide an electrochemical sensor for sensing an analyte in a fluid. Merely by way of example and not as a limitation, in certain aspects of the present invention, the analyte being sensed comprises a pH of the fluid. Merely by way of example and not as a limitation, in other aspects, the analyte may comprise hydrogen, hydrogen sulphide, carbon dioxide and/or the like.

An electrochemical sensor for measuring an analyte in a fluid, the electrochemical sensor having a first working electrode that includes a redox species sensitive to the analyte to be measured and a second working electrode made from a conducting substrate absent the redox species. The electrochemical sensor being capable of operation so that electrochemical effects of active contaminants in the fluid can be removed/attenuated from electrochemical signals produced by the reduction/oxidation of the redox species in the presence of the analyte.

In one embodiment of the present invention, an electrochemical sensor for measuring an analyte in a fluid is provided that comprises a first working electrode that comprises a conducting substrate and a first set of redox species sensitive to the analyte and a second working electrode that comprises a conducting substrate. The electrochemical sensor comprises a counter electrode and a reference electrode. A potential sweep is applied between the first working electrode and the counter electrode and the second working electrode and the counter electrode. Currents flowing at the first and the second working electrode as the potential is swept between the working electrodes and the counter electrode are measured and output to a processor. The processor receives the current data from the two working electrodes and removes signals from active contaminants in the fluid from the current data from the first working electrode. The processor processes a measurement for the analyte in the fluid from reduction/oxidation peaks in the processed/resolved current data from the first working electrode.

In some embodiments, the first working electrode includes a second redox species that is insensitive to the analyte being measured. In such embodiments, measurements of the analyte are processed from a separation between reduction/oxidation peaks from the first and the second redox species in the processed/resolved current data from the first working electrode.

In certain embodiments of the present invention, the first and the second working electrodes are made of the same conducting substrate. In one embodiment, a working electrode for use in the electrochemical sensor of the present application is described, the working electrode comprising a redox species sensitive to the analyte to be measured and a conducting substrate made of the same material as the conducting substrate of the second working electrode. In certain aspects, the conducting substrate of the working electrode are the same as those of the second working electrode.

Merely by way of example, the first and the second working electrodes are disposed so that the counter electrode is positioned between them. In some embodiments of the present invention, the first and the second electrode are disposed symmetrically around the counter electrode. In other embodiments, the two working electrodes may be disposed equidistant from the counter electrode.

In various embodiments of the present invention, location of a reduction/oxidation peak, i.e., the potential producing the peak may be known. In other embodiments, separation between reduction/oxidation peaks of different redox species, sensitive and/or insensitive to the analyte, may be known/predicted. These known locations/separation of the oxidation/reduction peaks may be used to provide for removal of electrochemical effects of the active contaminants and/or the processing of the oxidation/reduction peak(s) in the p[recessed/resolved current flow data from the redox species sensitive to the analyte. In some embodiments, the electrochemical sensor may comprise three or more electrodes.

One or more potentiostats may be used to provide the potential sweep(s) between the two working electrodes and the counter electrode and/or measure the current flowing at each of the two working electrodes. Other devices such as voltmeters, potentiometers, ammeters, amplifiers, power sources and/or the like may be used to create the potential sweep and/or measure the electrical properties of a current flowing at the working electrodes. In some aspects the potential sweep comprises a square wave sweep. The current and potential information for each of the two working electrodes may be used to create a voltammogram and the two voltammograms may be processed to produce a resolved voltammogram for the working electrode comprising the sensitive redox species. In some aspects, amperometric measurements, i.e. height of the reduction/oxidation peak may be used in the processing of the measurement of the analyte.

These and other features of the invention, embodiments and variants thereof, possible applications and advantages may become appreciated and understood by those skilled in the art from the following detailed description and drawings.

### BRIEF DESCRIPTION OF DRAWINGS

The present disclosure is described in conjunction with the appended figures:

FIG. 1 shows a schematic diagram of the main elements of a known voltametric sensor;

FIGS. 2A-C show schematic-type diagrams of the main elements of a known electrochemical microsensor and its operation;

FIG. 3 shows a schematic diagram of a known downhole probe using potentiometric sensors;

FIG. 4A illustrates the surface structure of a working electrode in accordance with an embodiment of the present invention;

FIG. 4B illustrates the surface structure of a working electrode with an internal reference electrode in accordance with an embodiment of the present invention;

FIG. 4C illustrates the redox reaction of a working electrode in accordance with another embodiment of the present invention using multi-walled carbon nanotubes;

FIG. 4D illustrates the redox reaction of a working electrode with internal reference electrode in accordance with another embodiment of the present invention; using multi-walled carbon nanotube;

FIG. 4E illustrates the geometrical surface layout of the working electrode of FIG. 4B, in accordance with an embodiment of the present invention;

FIG. 5 is a perspective view, partially cut-away, of an electrochemical sensor in accordance with an embodiment of the present invention;

FIG. 6 shows voltammograms recorded from an electrochemical sensor, in accordance with an embodiment of the present invention, at three different pH values;

FIG. 7A illustrates the shift of the peak potential for anthraquinone, diphenyl-p-phenylenediamine and a combination of the two redox species, in accordance with an embodiment of the present invention;

FIGS. 7B-7E are plots of peak potential against pH for the redox species of FIGS. 4C and 4D, respectively, over the pH range pH 1.0 to pH 12.0 under various conditions, in accordance with an embodiment of the present invention.

FIG. 8 illustrates an example of an electrochemical sensor, in accordance with an embodiment of the present invention, as part of a wireline formation testing apparatus in a wellbore;

FIG. 9 shows a wellbore and the lower part of a drill string including the bottom-hole-assembly, with a sensor in accordance with the invention;

FIG. 10 shows an electrochemical sensor, in accordance with the invention, located downstream of a venturi-type flowmeter;

FIG. 11 is a schematic-type representation of an electrochemical sensor, in accordance with an embodiment of the present invention;

FIG. 12A illustrates erroneous results (peaks produced by active species other than the redox species of the system) produced from an electrochemical sensor, in accordance with an embodiment of the present invention.

FIG. 12B shows a redox species for use in an embodiment of the present invention having an electron withdrawing or donating group added to the redox species.

FIG. 12C illustrates an electrochemical sensor in accordance with an embodiment of the present invention comprising one or more secondary working electrodes that do not include the redox species of the one or more primary working electrodes.

FIG. 12D illustrates an electrochemical sensor in accordance with an embodiment of the present invention in which the sensing electrode(s) comprises at least a first and a second redox species that are both insensitive to an analyte, where a peak-to-peak separation of the voltammetric responses of two insensitive redox species is known.

FIG. 13 is a schematic-type representation of an electrochemical sensor, in accordance with an embodiment of the present invention; and

FIG. 14 is a flow-type description of a method for operating an electrochemical sensor, in accordance with an embodiment of the present invention

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides exemplary embodiments of the present invention only, and is not intended to limit the scope, applicability or configuration of the invention. Rather, the ensuing description of the exemplary embodiments will provide those skilled in the art with an enabling description for implementing an embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the following description, the term “sensitive” means that the redox system reacts with an analyte to undergo reduction/oxidation and/or the redox system undergoing reduction/oxidation is perturbed by the presence and concentration of the analyte under an applied potential difference. In the following description, the term “insensitive” means that the redox system does not reacts with the analyte to be measured to undergo reduction/oxidation and/or the redox system undergoing reduction/oxidation is not perturbed by the presence and concentration of the analyte to be measured under an applied potential difference.

An electrochemical sensor comprising sensitive redox species provides an effective way of measuring analytes that react with the sensitive redox species to undergo reduction/oxidation and/or perturb the reduction/oxidation of the sensitive redox species. However, in operation, active contaminants/substances or the like, may themselves interact with and/or perturb the sensitive redox species and, as a result, interfere with operation of the electrochemical sensor.

Previously, to avoid such interferences with active contaminants, the chemistry of the sensitive redox species was tuned so that it underwent oxidation/reduction at a potential that was different from/away from the potential of electrochemical effects produced by the active contaminants. Applicants have found that—even though in an unturned system the electrochemical facts of the active contaminants may be close to or overlap a reduction/oxidation peak for the sensitive redox species and/or even though the electrochemical effects of the active contaminants may be spread out over different potentials and may give rise to many different voltammetric peaks—processing of reduction/oxidation peaks for the sensitive redox species can be performed by using a working electrode comprising a conducting substrate, obtaining voltammetric data from this working electrode and subtracting this voltammetric data from voltammetric data produced by a working electrode comprising a conducting substrate and the sensitive redox species. Applicants have found that peak identification in the voltammetic output from the electrode comprising only the conducting substrate can be used to identify specific effects of the active contaminants. By producing a mathematical description of such peaks, i.e. by looking at first, second etc differentials of the peak data or integrations under the peaks, the mathematical descriptions can be used to process the electrochemical data produced from the working electrode comprising the sensitive redox species to more accurately remove the effects of the active contaminant(s).

The theory of voltammetry and its application to surface water measurements at ambient temperatures are both well developed. The method is based on the measurement of the electromotive force (e.m.f.) or potential E in a potentiometric cell which includes measuring and reference electrodes (half-cells).

FIG. 1 shows the general components of a known voltammetric cell 10. A measuring electrode 11 is inserted into a solution 13. This electrode consists of an internal half element (for example, Ag wire covered by an AgCl salt) in a solution of a fixed pH (for example, 0.1M HCl in some pH electrodes), and an ion-selective membrane 111 (like glass H⁺ selective membrane in pH glass electrode). The reference electrode 12 also contains an internal half-element (typically the same AgCl; Ag) inserted in a concentrated KCl (for example 3M) solution/gel saturated with Ag⁺, which diffuses (or flows) through the reference (liquid) junction 121.

The ion-selective electrode 11 measures the potential that arises because of the difference in activity or concentration of a corresponding ion (H⁺ in case of pH) in the internal solution and in the measured solution. This potential is measured against the reference potential on the reference electrode 12, which is fixed because of a constant composition of a reference solution/gel. The electrodes may be separated (separate half cells), or combined into one (“combination electrode”).

The measured e.m.f. is an overall function of the temperature and the activity of an ith ion, to which the measuring electrode is selective:

E=E⁰+(k*T)*log (aᵢ), [1]

where E is the measured electromotive force (e.m.f.) of the cell (all potentials are in V), aᵢ corresponds to the activity of the ith ion and is proportional to its concentration. E⁰ is the standard potential (at temperature T) corresponding to the E value in a solution with the activity of ith ion equal to one. The term in parenthesis is the so-called Nernstian slope in a plot of E as a function of log(aᵢ). This slope (or the constant “k”) together with the cell (electrode) constant (E⁰) is experimentally determined via a calibration procedure using standard solutions with known activities of ith ion. For good quality undamaged electrodes this slope should be very close to the theoretical one, equal to (R*T/F*z), where F is the Faraday constant (96485 kJ/mole), R is the gas constant (8.313 j/mole K), zᵢ is the charge of ith ion.

The Nernst equation [1] can be rewritten for pH sensors, i.e. log a(H⁺) as

E_{0.5}=K−(2.303 RTm/nF)pH [2]

where E_{0.5} is the half-wave potential of the redox species involved, K is an arbitrary constant, R is the ideal gas constant, m is the number of protons and n is the number of electrons transferred in the redox reaction.

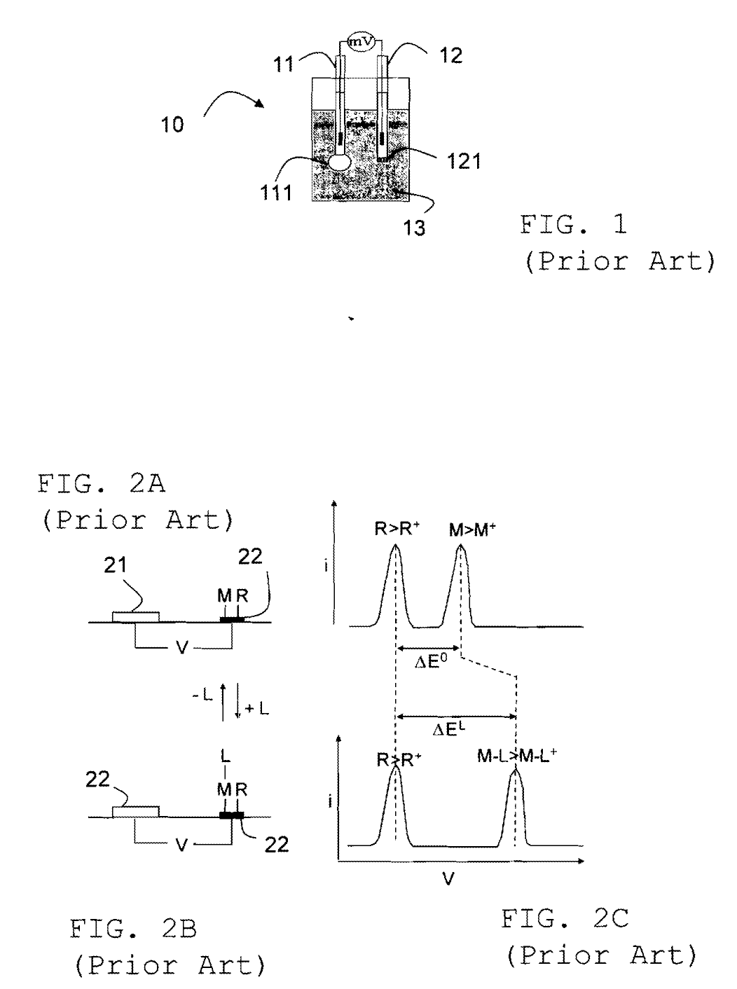

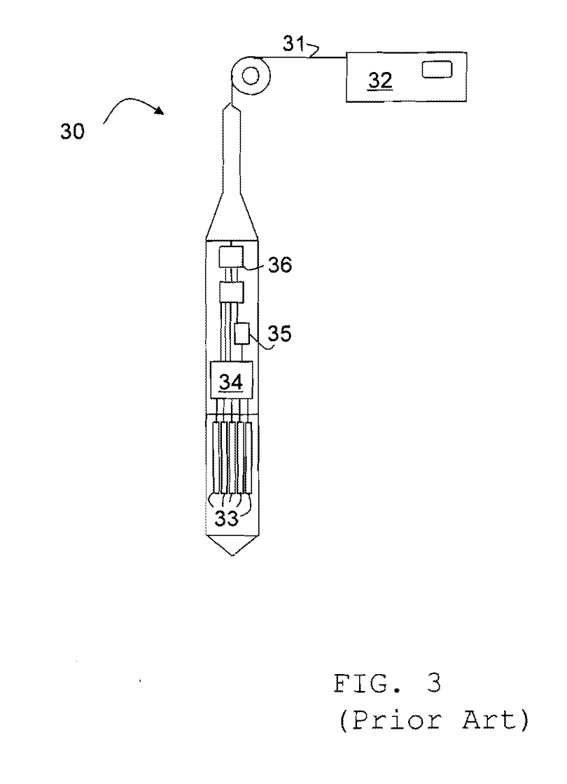

FIGS. 2A & 2B show a schematic electro-chemical sensor with a counter electrode 21 and a relatively much smaller (by a factor of 1000) Au substrate 22 that carries two molecular species M and R. The R species forms an inert reference electrode, and species M is an indicator electrode with specific receptors or sensitivity for a third species L. The schematic linear sweep voltammogram in the upper half of FIG. 2C shows the difference in the current peaks for the oxidization in the normal state. When the third species L binds to M (FIG. 2B), this difference increases as illustrated by the shift of peaks in the lower half of FIG. 2C, thus providing a measure for the concentration of L in the solution surrounding the sensor. In the context of the present invention, it is important to note that the R is specifically selected to be insensitive to the species L, e.g. pH.

In FIG. 3, there are schematically illustrated elements of a known downhole analyzing tool 30. The body of the tool 30 is connected to the surface via a cable 31 that transmits power and signals. A computer console 32 controls the tool, monitors its activity and records measurements. The tool 30 includes a sensor head with at number of selective electrochemical probes 33 each sensitive to a different molecular species. Also housed in the body of the tool are further actuation parts 34 that operate the head, a test system 35 and transceivers 36 to convert measurements into a data stream and to communicate such data stream to the surface. The electrodes are located at the bottom part of the probe and include those for pH, Eh (or ORP), Ca²⁺ (pCa), Na⁺ (pNa), S²⁻ (pS), NH₄⁺ (pNH₄), and reference electrode (RE). H₂S partial pressure may be calculated from pH and pS readings.

In an embodiment of the present invention, an anthraquinone may be homogenously derivatised onto carbon particles (AQC)

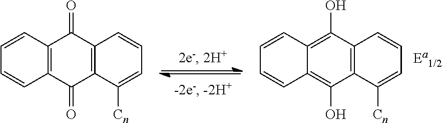

The AQC system is derived using 2 g of carbon powder (1.5 μm in mean diameter) mixed with a 10 cm³ solution containing 5 mM Fast Red AL Salt (Anthraquinone-1-diazonium chloride) to which 50 mM hypophosphorous acid (50%) is added. The reaction is allowed to stand with occasional stirring at 5° C. for 30 minutes, after which it is filtered by water suction. Excess acid is removed by washing with distilled water and with the powder being finally washed with acetonitrile to remove any unreacted diazonium salt in the mixture. It is then air dried by placing inside a fume hood for a period of 12 hours and finally stored in an airtight container.

In a similar manner, phen

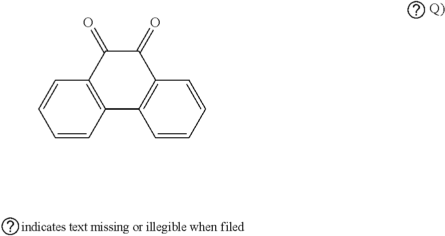

may be prepared as a molecular species to be attached to an electrode to undergo a redox reaction.

Alternatively, N,N′-diphenyl-p-phenylenediamine (DPPD) spiked onto carbon particles undergoes a redox process as shown below:

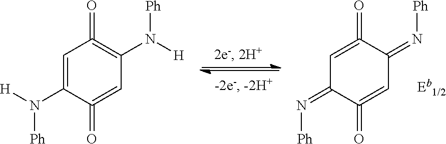

The bonding of DPPD onto carbon is achieved by mixing 4 g of carbon powder with 25 mL of 0.1M HCl+0.1M KCl and 20 mM DPPD solution in acetone. The reaction mixture is stirred continuously for 2 hours in a beaker and then filtered after which it was washed with distilled water to remove excess acid and chloride. It is then air dried by placing inside a fume hood for 12 hours and finally stored in an airtight container.

In a static environment, where the sensor surface is not exposed to a flow, it is possible to immobilize water insoluble DPPD crystals directly onto the electrode surface. However in the non-static environment it is preferred to link the sensitive molecules via a chemical bond to such a surface.

In some embodiments, the derivatised carbon powders may be immobilized onto a basal plane pyrolytic graphite (BPPG) electrode prior to voltammetric characterization following a procedure described by Scholz, F. and Meyer, B., “Voltammetry of Solid Microparticles Immobilised on Electrode Surfaces in Electroanalytical Chemistry” ed. A. J. Bard, and I. Rubenstein, Marcel Dekker, New York, 1998, 20, 1. Initially the electrode is polished with glass polishing paper (H00/240) and then with silicon carbide paper (P1000C) for smoothness. The derivatised carbons are first mixed and then immobilized onto the BPPG by gently rubbing the electrode surface on a fine qualitative filter paper containing the functionalized carbon particles.

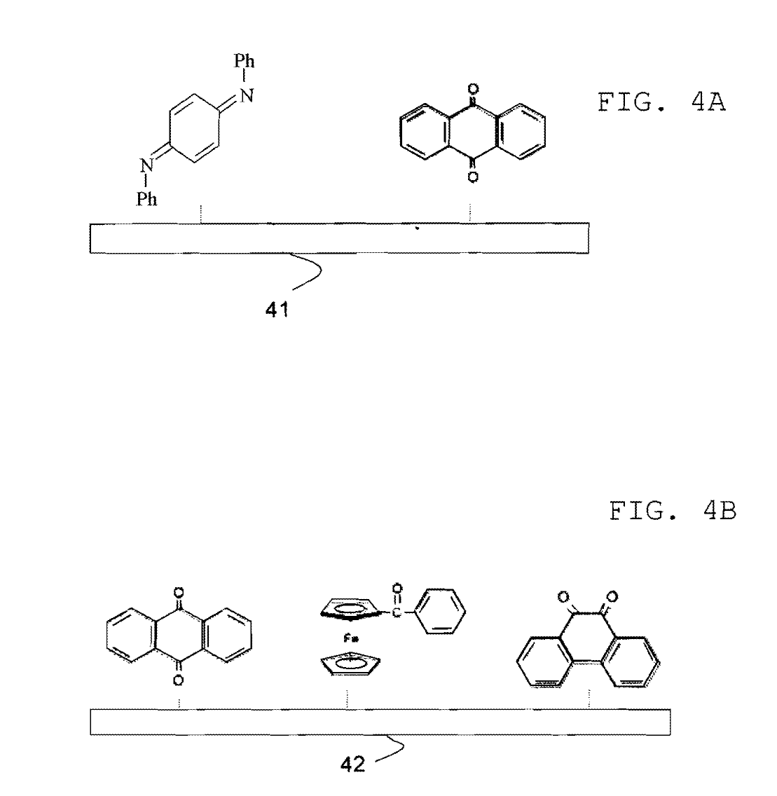

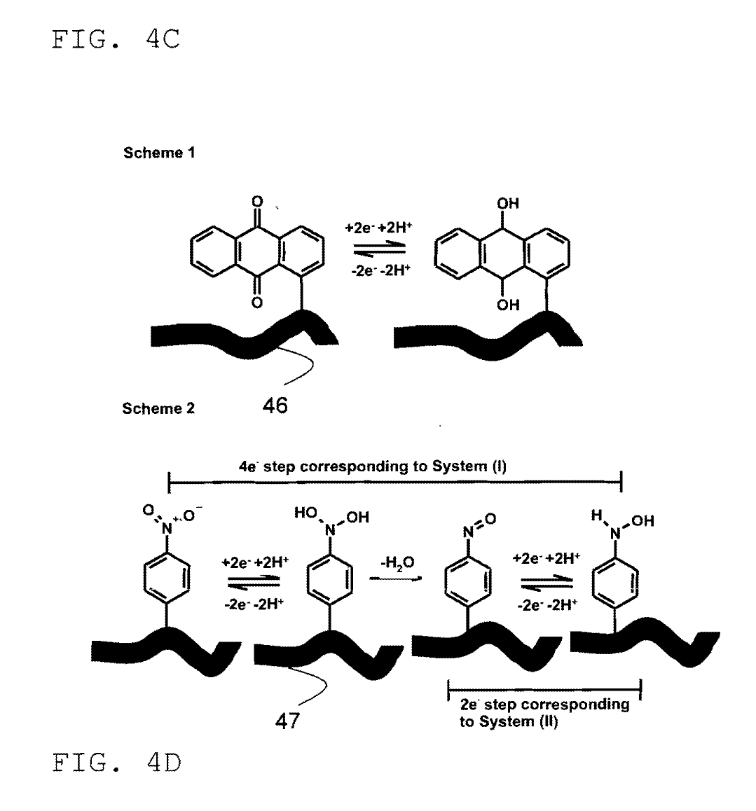

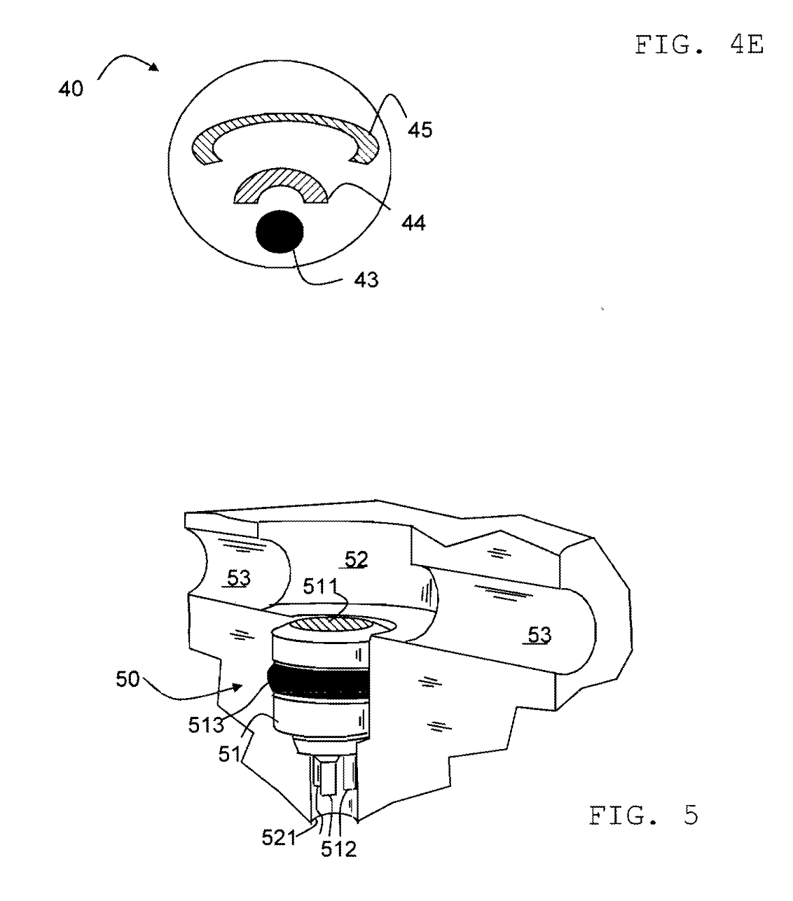

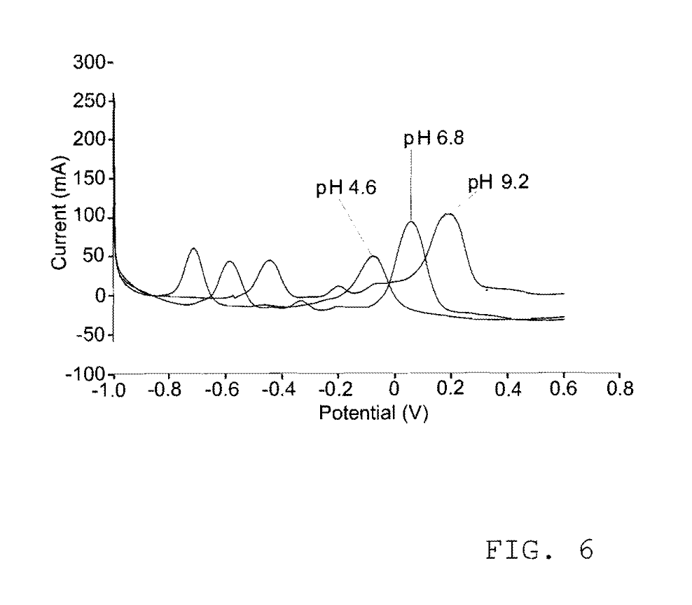

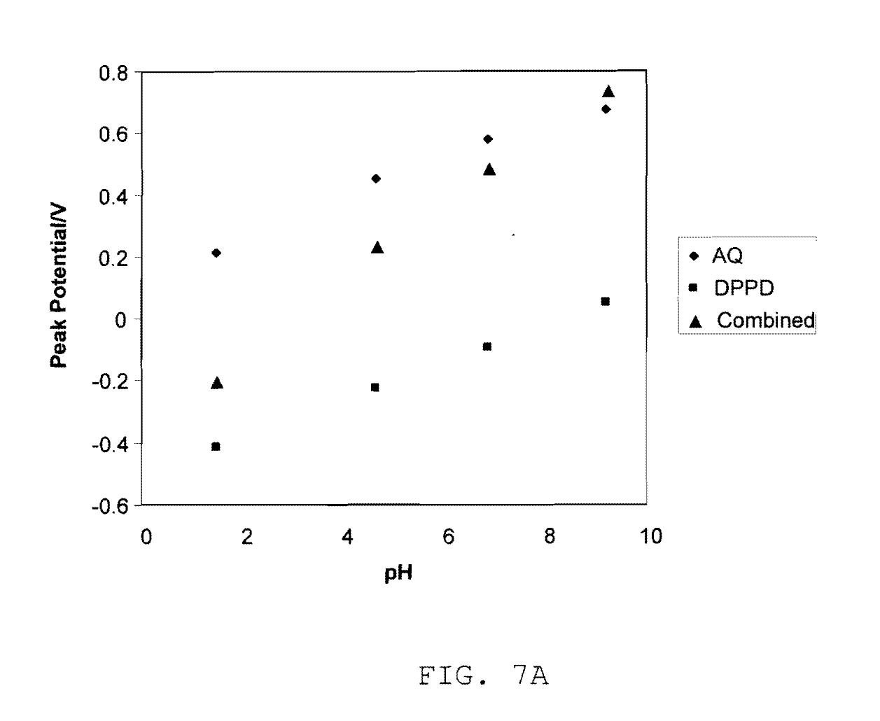

The resulting modified electrode surface is schematically illustrated by FIG. 4A showing an electrode 41 with bonded DPPD and AQC.

In some embodiments, an internal pH reference involving a pH independent redox couple may be used to increase the stability of any voltammetric reading, hence circumventing uncertainties caused by drift of the external reference electrode. In such a configuration, the sensor may in some aspects include two reference electrodes.

A suitable reference molecule may be, for example, K₅Mo(CN)₈ or various ferrocene containing molecules, which both have a stable redox potential (K₅Mo(CN)₈ at around 521 mV) that is sufficiently separated from expected shifting of redox signals of the two indicator species over the pH range of interest. As shown in Table 1 that both the oxidation and reduction potentials of K₅Mo(CN)₈ are fairly constant across the entire pH range

TABLE 1

| pH | AQ_{OX} | AQ_{RED} | DPPD_{OX} | DPPD_{RED} | Mo-_{OX} | Mo-_{RED} |
|---|---|---|---|---|---|---|
| 4.6 | −0.440 | −0.448 | 0.202 | 0.224 | 0.524 | 0.524 |
| 6.8 | −0.576 | −0.580 | 0.094 | 0.082 | 0.528 | 0.522 |
| 9.2 | −0.710 | −0.674 | −0.204 | −0.372 | 0.512 | 0.508 |

The Mo-based reference species can be retained in the solid substrate via ionic interactions with co-existing cationic polymer, such as poly(vinyl pyridine), that was spiked into the solid phase. Other pH independent species, such as ferrocyanide may also be used, however, the redox peaks may be obscured by the signals of the measuring redox species.

In FIG. 4B the electrode 42 carries bonded molecules AQC and PAQ together with PVF as an internal reference molecule.

The most common forms of conducting carbon used in electrode manufacture are glassy carbon, carbon fibres, carbon black, various forms of graphite, carbon paste and carbon epoxy. One further form of carbon, which has seen a large expansion in its use in the field of electrochemistry since its discovery in 1991 is the carbon nanotube (CNT). The structure of CNTs approximates to rolled-up sheets of graphite and can be formed as either single or multi-walled tubes. Single-walled carbon nanotubes (SWCNTs) constitute a single, hollow graphite tube. Multi-walled carbon nanotubes (MWCNTs) on the other hand consist of several concentric tubes fitted one inside the other.

The above activation methods for binding a redox active species to graphite or carbon surfaces can be extended via the chemical reduction of aryldiazonium salts with hypophosphorous acid, to include the covalent derivatization of MWCNTs by anthraquinone-1-diazonium chloride and 4-nitrobenzenediazonium tetrafluoroborate. This results in the synthesis of 1-anthraquinonyl-MWCNTs (AQ-MWCNTs) and 4-nitrophenyl-MWCNTs (NB-MWCNTs) as shown in FIGS. 4C and 4D, respectively. The respective substrates 46 and 47 are multi-walled carbon nanotubes.

The preparation process of the derivatised MWCNT involves the following steps: first 50 mg of MWCNTs are stirred into 10 cm³ of a 5 mM solution of either Fast Red AL (anthraquinone-1-diazonium chloride) or Fast Red GG (4-nitrobenzenediazonium tetrafluoroborate), to which 50 cm³ of hypophosphorous acid (H₃PO₂, 50% w/w in water) is added. Next the solution is allowed to stand at 5° C. for 30 minutes with gentle stirring. After which, the solution is filtered by water suction in order to remove any unreacted species from the MWCNT surface. Further washing with deionized water is carried out to remove any excess acid and finally with acetonitrile to remove any unreacted diazonium salt from the mixture. The derivatised MWCNTs arethen air-dried by placing them inside a fume hood for a period of 12 hours after which they are stored in an airtight container prior to use. Untreated multi-walled nanotubes can be purchased from commercial vendors, for example from Nano-Lab Inc of Brighton, Mass., USA in 95% purity with a diameter of 30+/−15 nm and a length of 5-20 m.

The reduction of diazonium salts using hypophosphorous acid as demonstrated is a versatile technique for the derivatization of bulk graphite powder and MWCNTs. This has the advantage over previous methods involving the direct electrochemical reduction of aryldiazonium salts onto the electrode surface, as the chemically activated method allows the possibility for inexpensive mass production of chemically derivatised nanotubes for a variety of applications. Furthermore the derivatization of MWCNTs proffers the possibility of sensor miniaturization down to the nano-scale.

Another way of immobilizing the redox active compounds onto the working electrode terminal may be by packing a mixture of the compounds and carbon powder effectively into a recessed working electrode cavity without a binding substance. The carbon powder could be mixed with the pH-sensitive and reference chemicals and ground finely with a mortar and pestle. Then the empty recess might be filled with the powder mix which would be mechanically compacted. The resulting void in the working electrode recess would then be refilled and compacted again. This would be repeated several times until the recess is full. The material would be pressed such that the particles are packed into a dense matrix.

Although packing of the redox active compounds into a single electrode area (as discussed above) provides a means of forming the sensor it can be envisaged that immobilization of two or more species into various distinct electrodes may provide improved signals and more facile manufacturing. This can be especially thought of when the compounds are chemically attached to the electrode surface via a covalent linkage. In this case a single monolayer of compounds will be formed on the surface.

It can be envisaged that in embodiments of the present invention in which a pH sensitive and a pH insensitive compound are coupled with the working electrode, the compounds may be bulky or undergo differing immobilization rates then formation of the monolayer will favor one or other of the compounds such that the signal is dominated by a single compound and hence the sensor is inoperable. In these cases, immobilization of each compound onto separate electrodes would overcome the problem, as the immobilization procedure for each would not be under competitive control. It can therefore be proposed that a sensor in which two or more working electrodes, with different electroactive species immobilized on each surface, is utilized and cross connected such that only a single voltammetric sweep is required.

For embodiments of the present invention, using either a combination of an insensitive redox species and a sensitive redox species or two or more different sensitive redox species, the methods for coupling the redox species to the working electrode discussed above may be used. Additionally, for either of these embodiments, the redox species whether it be sensitive or insensitive may be combined with a binding material or the like, such as an ink or the like, and screen printed onto the working electrode.

The above descriptions are merely examples of specific sensitive and insensitive redox species and methods of attaching these redox species to an electrode. While quinine moieties and/or derivatives and ferrocene moieties and/or derivatives may be used as sensitive and insensitive redox species any other redox species (chemical elements/compounds that may be oxidized and/or reduced) may be used in embodiments of the present invention.

In FIG. 4E there is shown a possible geometric configuration or layout for the sensor surface 40 which is exposed to the fluid to be tested, which may, merely by way of example be a wellbore fluid or the like. The surface includes a working electrode 43 as described in FIG. 4A or 4B, together with the reference electrode 44 and a counter electrode 45. The reference electrode 44, in some aspects of the present invention, may comprise an external electrode.

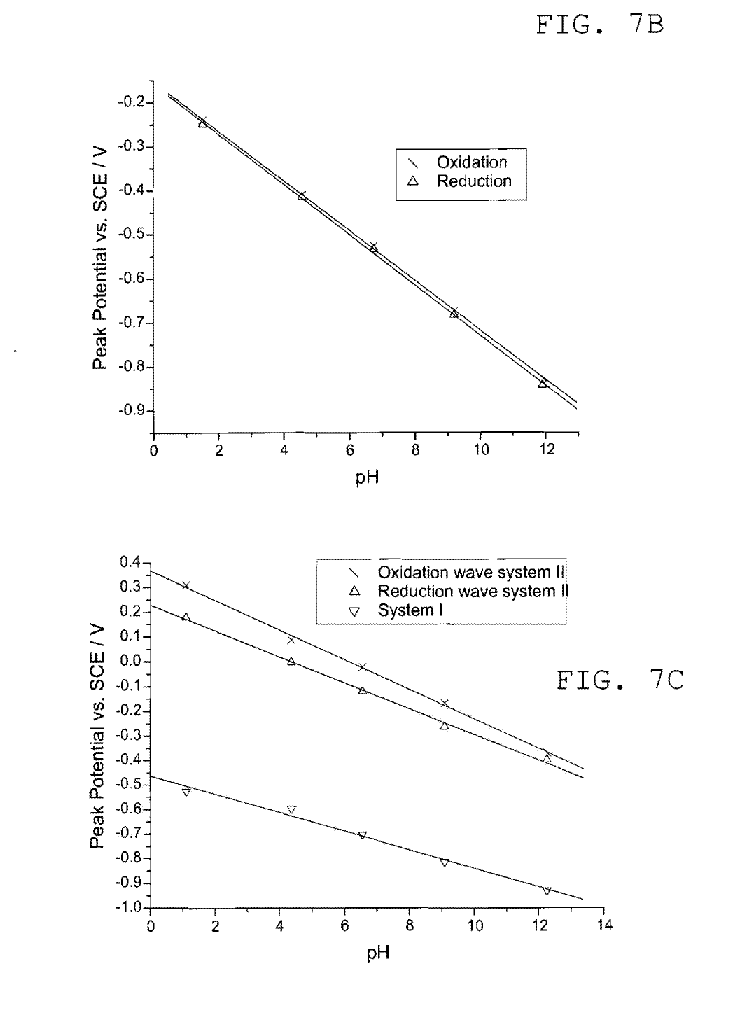

FIG. 5 provides a schematic of a microsensor incorporating a two working electrode electrochemical sensor, in accordance with an embodiment of the present invention. The body 51 of the sensor is fixed into the end section of an opening 52. The body carries the electrode surface 511 and contacts 512 that provide connection points to voltage supply and measurement through a small channel 521 at the bottom of the opening 52. A sealing ring 513 protects the contact points and electronics from the fluid to be tested that passes under operation conditions through the sample channel 53.

In some embodiments of the present invention, the electrochemical sensor may include two measuring or indicator electrodes or molecules measuring two e.m.f or potentials with reference to the same reference electrode and being sensitive to the same species or molecule in the environment. As a result, the sensitivity towards a shift in the concentration of the species may increase. Using the above example of AQC and DPPD and the pH (or H⁺ concentration, the Nernst equation applicable to the new sensor is the sum of the equations describing the individual measuring electrodes. Thus, combining the half wave potential E_{0.5}(AQC) for anthraquinone

E_{0.5}(AQC)=K(AQC)−(2.303 RTm/nF)pH [3]

with the half wave potential E_{0.5}(DPPD) for N,N′-diphenyl-p-phenylenediamine

E_{0.5}(DPPD)=K(DPPD)−(2.303 RTm/nF)pH [4]

yields the half wave potential E_{0.5}(S) for the combined system:

E_{0.5}(S)=E_{0.5}(AQC)+E_{0.5}(DPPD)=(K(AQC)+K(DPPD))−2*(2.303 RTm/nF)pH=K(S)−2*(2.303 RTm/nF)pH [5]

Where K(S) is the sum of the two constants K(AQC) and K(DPPD). As the shift of the potential with a change in pH depends on the second term, the (theoretical) sensitivity of the sensor has doubled.

The use of a further (third) redox species sensitive to the same species would in principle increase the sensitivity further. As the method detects shifts in the peak location of the voltammogram, however, more efforts are anticipated to be required to resolve overlapping peaks in such a three-molecule system.

However, in other embodiments of the present invention, a single redox species sensitive to a species may be used in combination with a redox species that is insensitive to the that species This configuration may provide in some circumstances for improved detection of the analyte then by using multiple redox species sensitive to the same species as there are less issues in such a sensor regarding redox peak detection, i.e., the use of multiple species sensitive to the same species requires the detection of multiple peaks on a voltammogram compared with identifying a single peak in a single redox species electrochemical sensor. However, in other circumstances it may be desirable to use an embodiment of the present invention comprising multiple redox species sensitive to the analyte to be detected.

FIG. 6 shows results in a range of pH solutions (pH 4.6, 0.1M acetic acid+0.1M sodium acetate buffer; pH 6.8, 0.025M disodium hydrogen phosphate +0.025M potassium dihydrogen phosphate buffer; pH 9.2, 0.05M disodium tetraborate buffer). The figure presents the corresponding square wave voltammograms when the starting potential was sufficiently negative to have both DPPD and AQ in their reduced forms.

In an embodiment of the present invention, square wave voltammetry may be used to provide for enhanced peak detection. While in certain aspects, linear sweep voltammetry and or cyclic voltammetry may be used for the electrochemical sensor, the use of square wave voltammetry may provide for producing more pronounced redox associated peaks.

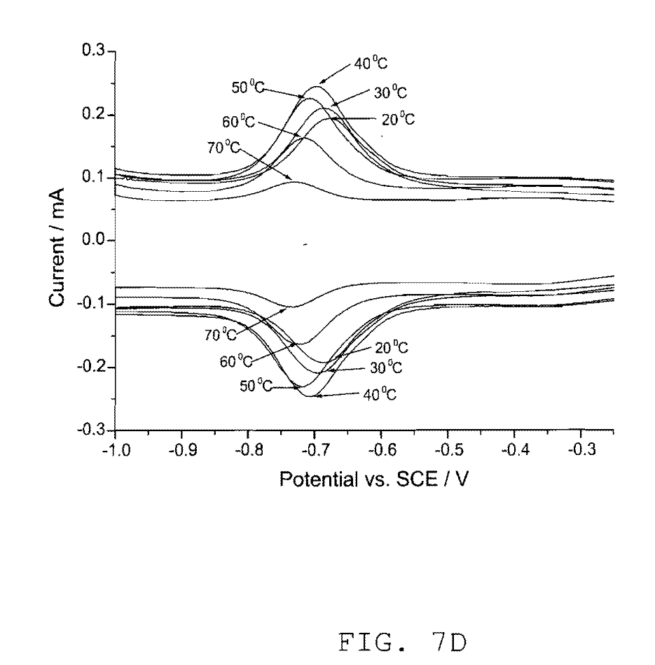

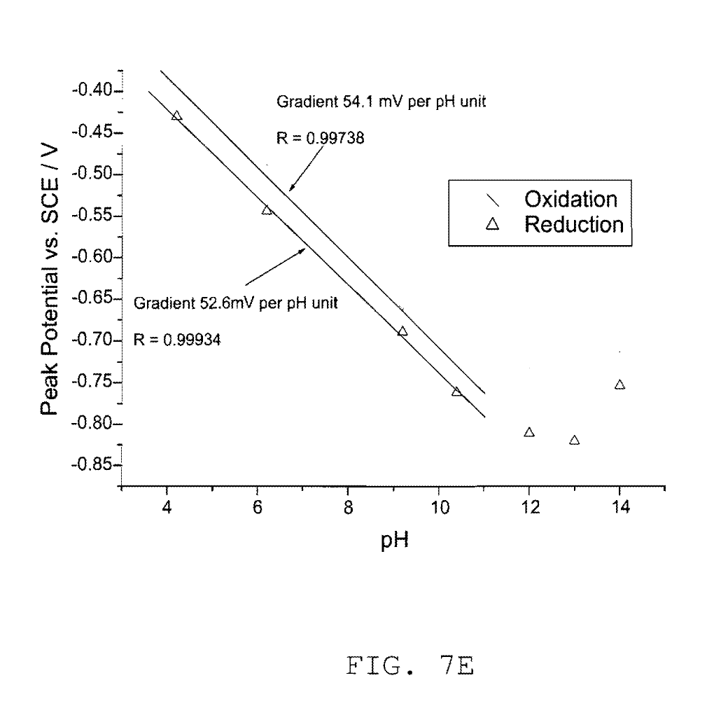

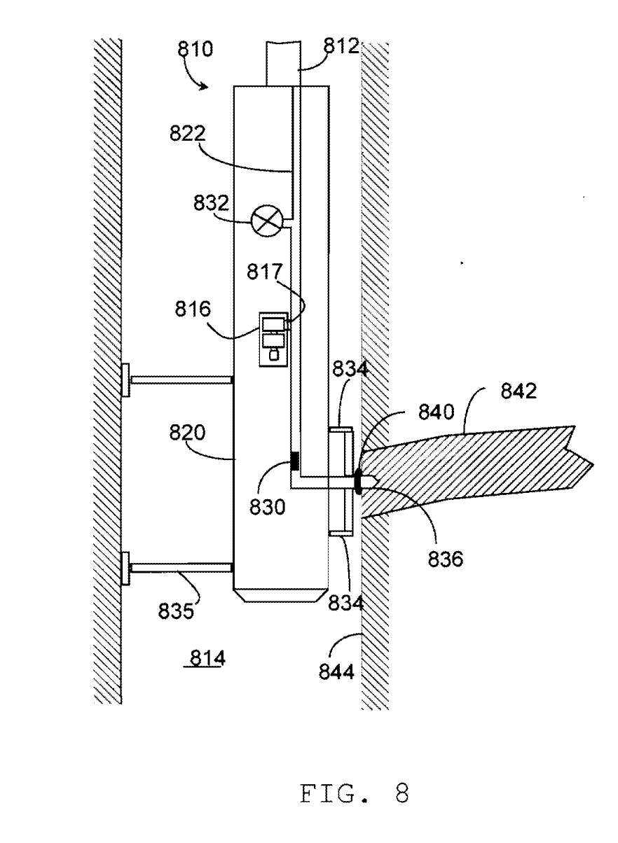

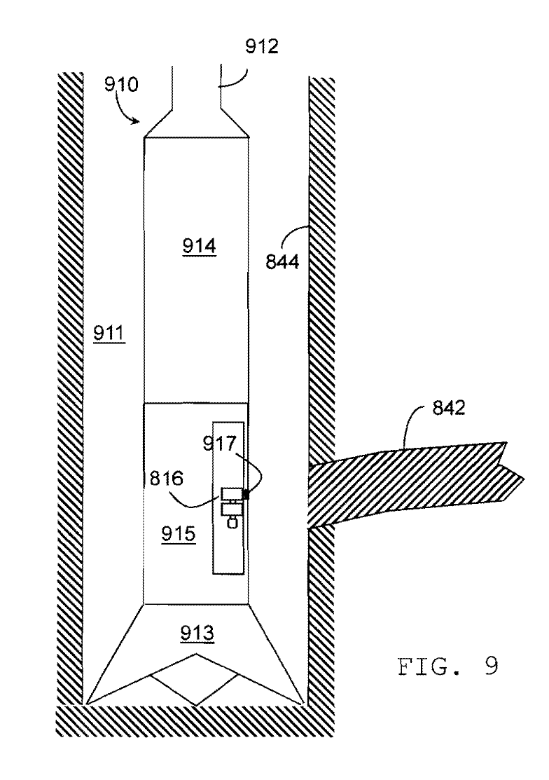

FIG. 7A depicts the relationship between the redox potential and pH for both the DPPD (▪) and AQ (♦). The plot reveals a linear response from pH 4 to 9 with a corresponding gradient of ca 59 mV/pH unit (at 25° C.) which is consistent with an n electron, m proton transfer where n and m are likely to be equal to two. By combining the two individual curves in a manner as described in equation [5], a new function (▴) is derived with a superior sensitivity for the species to be detected.

For the two activated MWCNT species described above, the peak potential using cyclic voltammetry (CV) is found to be pH-dependant. This voltammetric behavior is consistent with previous studies of carbon powder covalently modified with 1-anthraquinonyl groups and can be attributed to the two-electron, two-proton reduction/oxidation of the 1-anthraquinonyl moiety to the corresponding hydroquinone species.

When NB-MWCNTs is studied a more complicated voltammetric pattern can be observed. Upon first scanning in a reductive fashion a large, electrochemically irreversible peak is observed (labeled as system I), the exact peak potential of which depends on the pH studied. When the scan direction is reversed and swept in an oxidative fashion a new peak at more positive potentials than the irreversible peak is observed; which upon repeat cycling was found to behave in an electrochemically reversible fashion as the corresponding reduction wave was observed. This system is labeled as system II.

Again the exact peak potential of system II is found to vary with the pH studied. This behavior is consistent with the reduction mechanism of the nitro moiety in aqueous media as exemplified by nitrobenzene in FIG. 4D. It is worth noting that all subsequent characterization procedures for NB-MWCNTs are carried out on system II, which corresponds to the reversible arylnitroso/arylhydroxylamine couple, after several initial scans are performed to form this redox couple.

When investigating the effect of pH of AQ-MWCNTs and NB-MWCNTs over the range pH 1.0 to pH 12.0 using CV and square wave voltammetry (SWV) at room temperature as well as the behavior of AQ-MWCNTs at elevated temperatures up to 70° C. SWV was used because it provides us with a sharp, well-defined peak in a single sweep. As concomitant proton loss/gain occurs on oxidation/reduction of AQ-MWCNTs or NB-MWCNTs (see FIGS. 4C and 4D respectively) the peak potential depends on the local proton concentration, i.e. pH, as described by the Nernst equation [6]:

$${E}_{peak} = {E}_{formal}^{0} - \frac{2.3 RTm}{n F} pH \qquad [ 6 ]$$

where m and n, the number of protons and electrons transferred respectively, are both likely to be equal to two in the case of AQ-MWCNTs and the arylnitroso/arylhydroxylamine couple in the case of NB-MWCNTs. The formulation [6] of the Nernst equation is equivalent to those of equations [1] and [2].

At room temperature the peak potentials for both AQ-MWCNTs and NB-MWCNTs are found to shift to more negative potentials with increasing pH as predicted. A corresponding plot of peak potential against pH was found to be linear over the entire pH range studied in all cases (see FIGS. 7B and 7C, respectively) and a comparison of the gradient of the plots of peak potential versus pH were found to be close to the ideal value of 58.1 mV/pH unit with the exception of the irreversible peak (system I) for NB-MWCNTs which was found to shift by only 37.6 mV/pH unit.

The response of AQ-MWCNTs to pH at elevated temperatures up to 70° C. was studied using SWV. Note that the pH of the solutions used may vary with temperature, and so to this end three IUPAC buffers with a known pH at each temperature studied were employed. These are the pH 4.6, pH 6.8 and pH 9.2 buffers. The Nernst equation predicts that the peak potential should shift to more negative values as the temperature is increased due to the temperature dependence of the formal potential (E_{Peak}⁰).

FIG. 7D does indeed reveal that as the temperature is increased the peak potential is shifted to more negative values. However, in contrast to the behavior of carbon powder covalently derivatised with the anthraquinonyl moiety (AQcarbon), where the peak currents increase steadily with increasing temperature after an initial increase in peak current up to ca 40° C., the peak currents for AQ-MWCNTs gradually decreases with increasing temperature. This behavior has also been previously observed for MWCNT agglomerates at elevated temperatures. The temperature invariance of derivatised MWCNTs is not fully understood, but has a potential advantage for pH sensors according to some embodiments of the present invention, which are required for use in elevated temperature environments.

In FIG. 7E there is illustrated the effect of varying pH at room temperature for molecular anthraquinone in the solution phase versus the AQ-MWCNTs immobilized onto a bppg electrode. One (1) mM anthraquinone solutions are prepared at each pH and studied using cyclic voltammetry at a bare bppg electrode. The variation of peak potential with pH for both cases over the pH range 1.0 to 14.0 are studied with additional experiments carried out at pH 10.5, pH 13.0 and pH 14.0. The plot of peak potential versus pH for both 1 mM anthraquinone in solution and for the immobilized AQ-MWCNTs reveals that, in the case of AQ-MWCNTs, a linear response is observed over the entire pH range studied.

However for the anthraquinone in the solution phase, the plot is no longer linear above ca. pH 10.5 (FIG. 7E). This can be attributed to the pKa for the removal of the first proton, pKa₁, of the reduced form of anthraquinone (see FIG. 4C) in solution being ca. pKa₁=10. The pKa for the removal of the second proton is ca pKa₂=12. At higher pHs than pH 10 the reduced form of anthraquinone may be deprotonated causing a change in the variation of peak potential with pH. No such deviation from linearity is observed for the AQ-MWCNTs. From this it may be concluded that derivatization onto the surface of the MWCNTs may change the pKₐ of the anthraquinonyl moiety. This demonstrates that derivatization onto MWCNTs may prove advantageous to the analytical sensing of pH as the pH window for use is favorably widened for derivatised AQ-MWCNTs compared to free anthraquinone in solution.

Analysis of the peak potential as a function of pH at each temperature shows good agreement between the experimental and theoretically predicted values thereby showing the mechanism can be readily used as a simple, inexpensive pH electrochemical sensor, which sensor works over a wide range of temperatures. Merely by way of example, the novel sensor may be placed inside various wellbore tools and installations as described in the following examples.

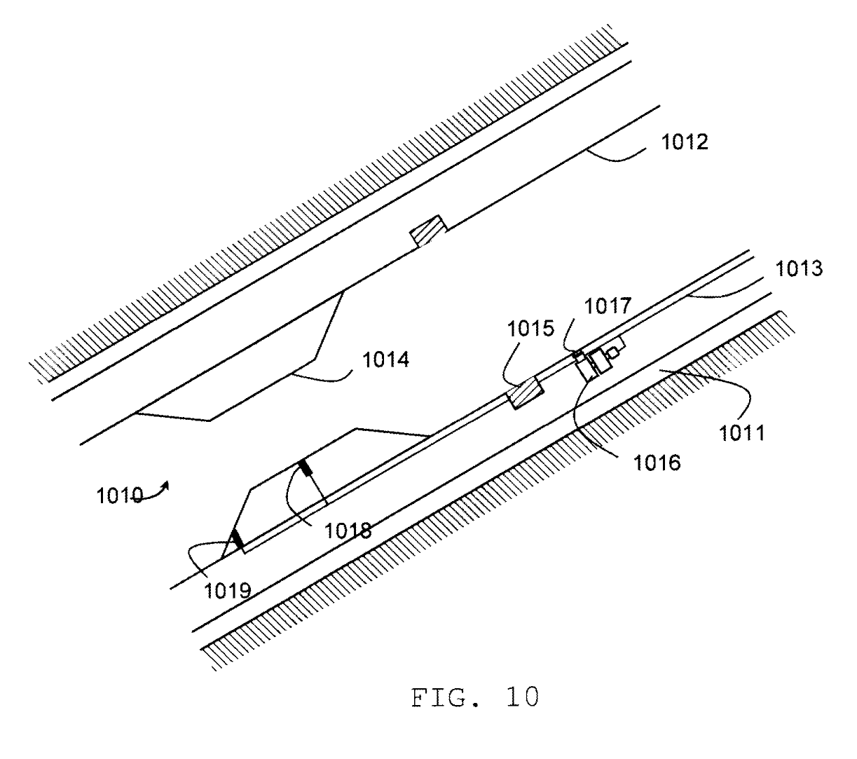

In FIGS. 8-10 the sensor is shown in various possible downhole applications.

In FIG. 8, there is shown a formation testing apparatus 810 held on a wireline 812 within a wellbore 814. The apparatus 810 is a well-known modular dynamic tester (MDT, Mark of Schlumberger) as described in the co-owned U.S. Pat. No. 3,859,851 to Urbanosky, U.S. Pat. No. 3,780,575 to Urbanosky and U.S. Pat. No. 4,994,671 to Safinya et al., with this known tester being modified by introduction of a electrochemical analyzing sensor 816 as described in detail above (FIG. 8). The modular dynamics tester comprises body 820 approximately 30 m long and containing a main flowline bus or conduit 822. The analysing tool 816 communicates with the flowline 822 via opening 817. In addition to the novel sensor system 816, the testing apparatus comprises an optical fluid analyser 830 within the lower part of the flowline 822. The flow through the flowline 822 is driven by means of a pump 832 located towards the upper end of the flowline 822. Hydraulic arms 834 and counterarms 835 are attached external to the body 820 and carry a sample probe tip 836 for sampling fluid. The base of the probing tip 836 is isolated from the wellbore 814 by an o-ring 840, or other sealing devices, e.g. packers.

Before completion of a well, the modular dynamics tester is lowered into the well on the wireline 812. After reaching a target depth, i.e., the layer 842 of the formation which is to be sampled, the hydraulic arms 834 are extended to engage the sample probe tip 836 with the formation. The o-ring 840 at the base of the sample probe 836 forms a seal between the side of the wellbore 844 and the formation 842 into which the probe 836 is inserted and prevents the sample probe 136 from acquiring fluid directly from the borehole 814.

Once the sample probe 836 is inserted into the formation 842, an electrical signal is passed down the wireline 812 from the surface so as to start the pump 832 and the sensor systems 816 and 830 to begin sampling of a sample of fluid from the formation 842. The electrochemical detector 816 is adapted to measure the pH and ion-content of the formation effluent.

A bottle (not shown) within the MDT tool may be filled initially with a calibration solution to ensure in-situ (downhole) calibration of sensors. The MDT module may also contain a tank with a greater volume of calibration solution and/or of cleaning solution which may periodically be pumped through the sensor volume for cleaning and re-calibration purposes.

Electrochemical probes in an MDT-type downhole tool may be used for the absolute measurements of downhole parameters which significantly differ from those measured in samples on the surface (such as pH, Eh, dissolved H₂S, CO₂). This correction of surface values is important for water chemistry model validation.

A further possible application of the novel sensor and separation system is in the field of measurement-while-drilling (MWD). The principle of MWD measurements is known and disclosed in a vast amount of literature, including for example U.S. Pat. No. 5,445,228, entitled “Method and apparatus for formation sampling during the drilling of a hydrocarbon well”.

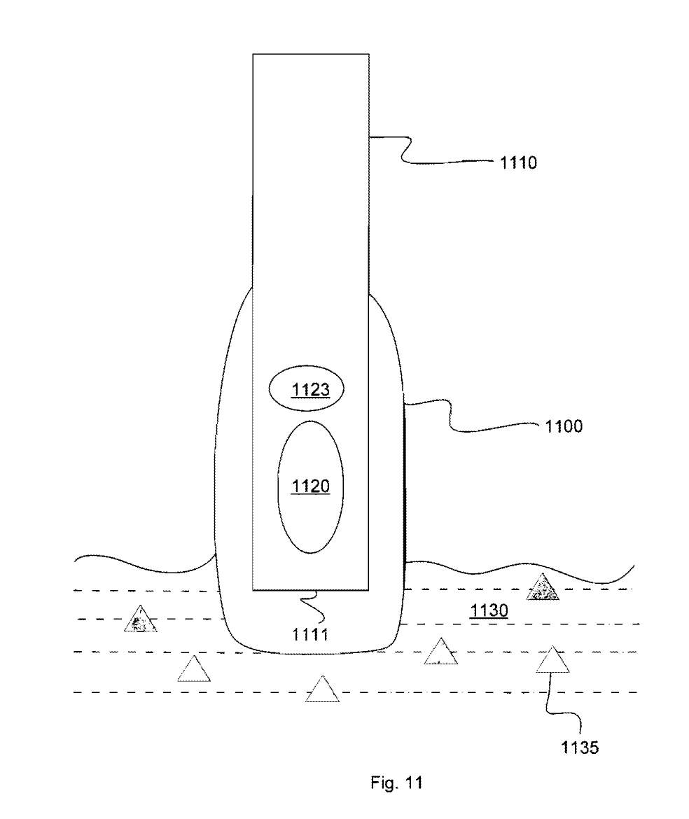

In FIG. 9, there is shown a wellbore 911 and the lower part of a drill string 912 including the bottom-hole-assembly (BHA) 910. The BHA carries at its apex the drill bit 913. It includes further drill collars that are used to mount additional equipment such as a telemetry sub 914 and a sensor sub 915. The telemetry sub provides a telemetry link to the surface, for example via mud-pulse telemetry. The sensor sub includes the novel electrochemical analyzing unit 816 as described above. The analyzing unit 816 collects fluids from the wellbore via a small recess 917 protected from debris and other particles by a metal mesh.

During drilling operation wellbore fluid enters the recess 917 and is subsequently analyzed using sensor unit 816. The results are transmitted from the data acquisition unit to the telemetry unit 914, converted into telemetry signals and transmitted to the surface.

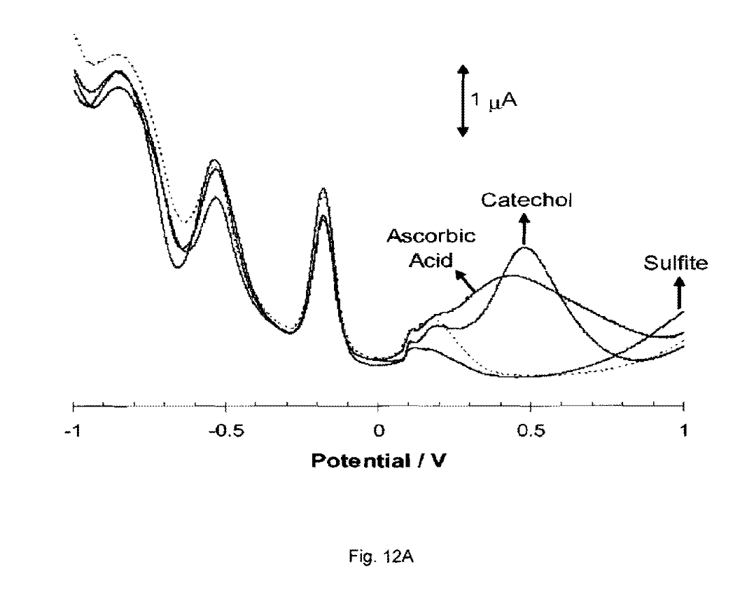

A third application is illustrated in FIG. 10. It shows a Venturi-type flowmeter 1010, as well known in the industry and described for example in the U.S. Pat. No. 5,736,650. Mounted on production tubing or casing 1012, the flowmeter is installed at a location within the well 1011 with a wired connection 1013 to the surface following known procedures as disclosed for example in the U.S. Pat. No. 5,829,520.

The flowmeter consists essentially of a constriction or throat 1014 and two pressure taps 1018, 1019 located conventionally at the entrance and the position of maximum constriction, respectively. Usually the Venturi flowmeter is combined with a densitometer 1015 located further up- or downstream.

The electrochemical analyzing unit 1016 is preferably located downstream from the Venturi to take advantage of the mixing effect the Venturi has on the flow. A recess 1017 protected by a metal mesh provides an inlet to the unit.

During production wellbore fluid enters the recess 1017 and is subsequently analyzed using sensor unit 1016. The results are transmitted from the data acquisition unit to the surface via wires 1013.

A further possible application for an embodiment of the present invention is in production logging. In order to determine the producing zones of a well, the well is traversed using a logging tool. For vertical and near vertical wells, the tool is allowed to move under gravity, controlled by a cable from the wellhead. For highly deviated wells, the tool is pushed/pulled using either coiled tubing from the surface, or a tractor powered via a cable from the surface.

A typical tool string comprises sensors for taking a series of measurements aimed at determining the flow distribution in the well, in terms of phase fractions and position. Measurements include spinners to determine a local velocity (distribution), and fluid fraction measurement probes—for example electrical or optical probes. These measurements are often used in combination in order to maximize the information gained from each pass of the well.

In certain aspects, a pH sensor according to an embodiment of the present invention, may be mounted onto this tool, and used to measure pH along a well. The pH of the aqueous phase may be determined by its composition, temperature and pressure and may reveal information on the influx of fluids into the well as well as the movement of fluids within the reservoir.

As well as revealing information on fluid influxes and flows within the reservoir, the pH measurement may also be used to assess those parts of the production system that are being exposed to high concentrations of acid gases (for which the associated aqueous phase will have a low pH—typically less than about a pH of 4), and are thus prone to corrosion. In certain aspects, this information may be used to determine the strategy for minimizing and/or mitigating corrosion, e.g. through the selective placement of corrosion inhibitors. U.S. Pat. No. 6,451,603 to G. M. Oddie describes how sensors might be incorporated within the blades of the spinners within a production logging tool and is hereby incorporated by reference in its entirety for all purposes.

In certain aspects, a sensor in accordance with an embodiment of the present invention may be incorporated within the blades of the spinners of a production and may provide for increasing mass transfer to the surface of the sensor.

In another aspect, a sensor in accordance with an embodiment of the present invention may be used in the monitoring of fluids pumped into a well for the purposes of fracturing, matrix treatments such as acidizing, or treatments for wellbore consolidation. pH is an important parameter that controls the property of some of these fluids, and monitoring its value may provide a means of assuring the quality of the treatment, particularly where fluids may be blended in surface modules, prior to being pumped downhole.

In addition to using surface monitoring for pumping fluids into a well, pH might be monitored, in accordance with an embodiment of the present invention, on the returns, when a well is brought back on production following the pumping of a treatment fluid. With the contrast in pH between a treatment fluid and the reservoir fluids, the efficacy of the treatment, and the placement of the treatment fluids, may be assessed.

In yet further aspects, a pH sensor, in accordance with an embodiment of the present invention, may be mounted on surface pumping units or blenders, or form part of a separate monitoring module, placed in-line and/or the like. In still further aspects, a sensor in accordance with an embodiment of the present invention may be deployed downhole on a coiled tubing unit, where the coiled tubing may be used to convey fluids downhole, and where the pH sensor may be located at the coiled tubing head, or as part of a measurement sub conveyed by the coiled tubing unit, and provide information on the state of the fluids downhole.

Another application of an embodiment of the present invention may be in the monitoring of underground bodies of water for the purposes of resource management. From monitoring wells drilled into the aquifers, one or more sensors, in accordance with an embodiment of the present invention, may be deployed on a cable from the surface—either for short duration (as part of a logging operation) or longer term (as part of a monitoring application). In certain aspects of the present invention, a pH sensor, in accordance with an embodiment of the present invention, may be used in the monitoring of aquifers, where long term unattended monitoring of pH is required, e.g. in the monitoring of shallow groundwater on top of CO2 storage, where the pH in the shallow groundwater may indicate whether CO2, injected into a deeper aquifer for the purposes of CO2 sequestration, is escaping to the surface. The pH sensor may be interfaced with a data-logger and the measurements from the sensor stored for later retrieval, may be transmitted to surface for direct analysis and/or the like.

In addition, in certain aspects, the deployment of the pH sensor within producing wells on a cable may provide information on produced water quality. In further aspects, the pH sensor may be deployed in injection wells, e.g. when water is injected into an aquifer for later retrieval, where pH may be used to monitor the quality of the water being injected or retrieved.

There may be a significant heterogeneity in the composition, and hence the pH, of waters produced from a reservoir: reflecting both the vertical and horizontal variations that exist in rock and fluid composition. These variations may arise from natural processes during the formation of a basin or may come about through the injection of fluids to improve oil recovery, e.g., CO2, surface waters or treatment fluids. Monitoring pH using an embodiment of the present invention beyond the wellhead in surface or subsea pipelines may provide information on the nature of the flow within a reservoir—providing information on events such as water breakthrough or the like—and/or may give warning when corrosion may become an issue because of abnormally low pH that may be due to un-reacted acid treatments returning to surface or because of the natural production of the acid gases H2S or CO2. A pH sensor in accordance with an embodiment of the present invention may be deployed beyond the wellhead, permanently or temporarily, within pipelines, or located at the manifolds where pipeline flows are brought together or divided.

In wells where reservoir pressures are insufficient, electrosubmersible pumps (“ESPs”) can be deployed within the well to increase production. These pumps are deployed from surface with a power cable and fluid injection lines. In certain aspects of the present invention, a pH sensor in accordance with an embodiment of the present invention may be deployed permanently on the ESP and may provide pH information that may be used to interpret fluid composition. In such aspects, the sensor may provide warning of potential materials failure from acid corrosion or the like. In addition to this application, alternative means of deployment of a sensor in accordance with an embodiment of the present invention may be within a permanent monitoring system, may be a part of a completion of a well and/or the sensors may be deployed through a casing of the wellbore to monitor the fluids outside of the casing, e.g. in assessing zonal isolation or the like.

While the preceding describe uses of the electrochemical sensor in the hydrocarbon and water industries, embodiments of the present invention may provide an electrochemical sensor for detecting an analyte in a whole host of industries, including food processing, pharmaceutical processing, medical, water management and treatment, biochemistry, research laboratories and/or the like. Merely by way of example, one embodiment of the present invention provides an electrochemical sensor for pH detection where the sensor may be essentially calibration free. Such an embodiment has utility in any and all industries where accurate detection and measurement of pH is required.

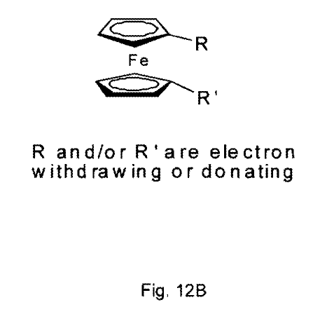

FIG. 11 is a schematic-type representation of a working electrode with polymer coating covering at least a portion of the working electrode, in accordance with one embodiment of the present invention. In an embodiment of the present invention, a polymer coating 1100 may be applied to a working electrode 1110 that is coupled with/comprises a sensitive redox species 1120; where the sensitive redox species 1120 is sensitive to an analyte 1135 to be detected. The analyte 1135 may be found in a fluid 1130, where the fluid 1130 may be a fluid that is being tested or the fluid 1130 may comprise a fluid into which the analyte is deposited/diffused, for example by diffusion from a sample flowing over a membrane (not shown) contacting the fluid 1130. In some aspects, the fluid 1130 may comprise a buffer solution.

The polymer coating 1100 may be configured to prevent leeching, diffusion and/or the like of the sensitive redox species 1120 into the fluid 1130. This may be important where the fluid 1130 is a fluid being tested and it is not desirable to contaminate the fluid 1130, for example the fluid may be water in a water treatment process, a batch of a pharmaceutical process, a food substance or the like. In other aspects, the electrochemical sensor/working electrode may be subject to human contact in use and it may be desirable to prevent such contact with the redox species.

Furthermore, the application of the polymer coating 1100 to the working electrode 1110 may serve to anchor the redox species to the working electrode 1110. As such, methods of fabrication of the working electrode may be used wherein the redox species is not chemically coupled to the working electrode 1110.

In an embodiment of the present invention, the working electrode may comprise both the sensitive redox species 1120 and as insensitive redox species 1123. In such an embodiment, the polymer coating 1100 may be configured to prevent leeching, diffusion and/or the like of either the sensitive redox species 1120 and/or the insensitive redox species 1123. Merely by way of example, in practice, the insensitive redox species 1123 is often the most problematic of the redox species to anchor to the working electrode 1110. This may be because of the properties of the insensitive redox species 1123 and/or the method of depositing the insensitive redox species 1123 on the working electrode 1110 or binding the insensitive redox species 1123 to the working electrode 1110.

To work effectively, the polymer coating 1100 should act to prevent leeching, diffusion, movement and/or the like of the insensitive redox species 1123 and/or the sensitive redox species 1120 from the working electrode to the fluid 1130. At the same time, the polymer coating 1100 should allow the fluid 1130 and/or the analyte 1135 to permeate, diffuse to, come into contact with, perturb and/or the like the sensitive redox species 1120 on the working electrode 1110.

Merely by way of example, in one embodiment of the present invention, the polymer coating 1100 may comprise a polysulphone polymer and in another embodiment, the polymer coating 1100 may comprise a polystyrene polymer. As persons of skill in the art may appreciate, other polymers may be used in accordance with an embodiment of the present invention provided the polymers do not interfere with the operation of the sensor.

In experiments using small amounts of polymer coated on the working electrode 1110, it was found from a plot of peak current against pH that there was steady decrease in peak current with time. This decrease in current is due to a redox species on the working electrode 1110 diffusing through the polymer coating 1100 into the fluid 1130. The redox species may be the sensitive redox species 1120 or the insensitive redox species 1123 that is coupled with the working electrode 1110. For example, the non-sensitive redox species 1123, which may comprise ferrocene or the like, may be attached to the working electrode 1110 to provide a reference that may be used to provide for peak-to-peak measurements of the redox peaks produced by the sensitive redox species 1120 and the insensitive redox species 1123. As noted above, in such aspects, the electrochemical sensor effectively has two reference electrodes. The processor may process a measurement of the analyte using the peak-to-peak separation of the redox peaks produced by the sensitive redox species 1120 and the insensitive redox species 1123.

Merely, by way of example, Applicants determined that low concentrations/low amounts of polymer are insufficient to prevent diffusion of the sensitive redox species 1120 and/or the insensitive redox species 1123 from the working electrode 1110 into the fluid being 1130. However, applicants found that an increased concentration of polymer may provide for effective operation of the electrochemical sensor and decreased diffusion of the sensitive redox species 1120 and/or the insensitive redox species 1123 into the fluid 1130. Furthermore, in certain aspects of the present invention, it may be easier or more efficient to bind/hold the sensitive redox species 1120 and/or the insensitive redox species 1123 to the working electrode 1110 when the polymer coating 1100 is present. In such aspects, the polymer layer 1100 may be configured with a consideration of retaining the sensitive redox species 1120 and/or insensitive redox species 1123 at the working electrode 1110 and/or ease of manufacturing the working electrode 1110.

Merely by way of example, in certain aspects, using a macro-electrode, of the order of 1 to 5 mm in diameter, the polymer layer 1100 may comprise 1000 micrograms of the polymer disposed over the working electrode 1110. However, such a large amount of the polymer may reduce the reaction time of the electrochemical sensor as it may take up to several hours for the fluid 1130 to diffuse through the polymer layer 1100 and interact with the working electrode 1110.

In some aspects, the sensitive redox species 1120 and/or the insensitive redox species 1123 may be disposed on a tip 1111 of the working electrode 1110 and the polymer layer 1100 may cover at least the tip 1111 of the working electrode 1110. In other aspects, the sensitive redox species 1120 and/or the insensitive redox species 1123 may cover an area or areas, which may be referred to as active areas, of the working electrode 1110 and the polymer layer 1100 may coat the active area(s). In other aspects, the working electrode 1110 may be coupled with a redox species and then covered with the polymer.

In one embodiment of the present invention, the concentration, amount and/or thickness of the polymer coating 1100 may be configured to provide for preventing contamination of the fluid 1130 and/or loss of the sensitive redox species 1120 and/or the insensitive redox species 1123 from the working electrode 1110 as well as for allowing diffusion of the analyte 1135 to the sensitive redox species 1120. In some embodiments, a working electrode of diameter less than 10 mm may be coated with over a thousand micrograms of polymer. In such an embodiment, it may take of the order of several hours for the analyte 1135 to overcome the polymer layer 1100 and interact with the sensitive redox species 1120. In certain aspects, where a response time of less than a matter of hours are required, less than 1000 micrograms of polymer may be used to coat a working electrode with a diameter of the order of 1-5 mm.

To produce an electrochemical sensor with a response time of the order of minutes or seconds with electrodes having diameters between 1-5 mm less than 500 micrograms of polymer may be used. Of course, the characteristics of the polymer chosen for the polymer coating 1100 will also affect the amount to be used. Merely by way of example, for a working electrode with a diameter between 1 and 5 mm, to produce a real-time response time and/or a response time of the order of seconds, about 200-400 micrograms of polystyrene may be deposited on the working electrode 1110 or about 10-400 micrograms of polysulfone may be deposited on the working electrode 1110.

To deposit the polymer in a generally uniform layer over the working electrode 1110, the polymer may be spin coated onto the working electrode 1110, dip coated onto the working electrode 1110, applied using solvent evaporation onto the working electrode 1110 and/or the like. In certain aspects, a screen printing process may be used to apply the sensitive redox species 1120, the insensitive redox species 1123 and/or the polymer coating 1100 to the working electrode 1110.

For example, for a solvent evaporation application of the sensitive redox species 1120 and/or the insensitive redox species 1123 to the working electrode 1110, the polymer may be dissolved in a solvent such as dichloromeathane (“DCM”) or the like. In some embodiments, a concentration/amount of the polymer layer 1100 applied on top of the working electrode 1110 is of the order of tens of milligrams of polymer in about 1-50 milliliters of solution. In other embodiments, a concentration/amount of the polymer layer 1100 applied on top of the working electrode 1110 is of the order of 5-50 of milligrams of polymer in about 1-20 milliliters of solution. In other embodiments, a concentration/amount of the polymer layer 1100 applied on top of the working electrode is of the order of 20-40 of milligrams of polymer in about 1-10 milliliters of solution. In one embodiment of the present invention, the working electrode 110 is coated with 25-35 mg of polymer dissolved in 2 ml of DCM and the DCM is then evaporated to leave a polymer layer on the working electrode 1110 comprising 25-35 micrograms of polymer.

In other embodiments of the present invention, the working electrode 1110 may comprise a micro-electrode. For such embodiments, the amount of polymer used to coat the micro-electrode may be between 1-10 micrograms or less than 1 microgram of the polymer. In such configurations, techniques associated with micro-fabrication may be used to apply the polymer to the micro-electrodes. In further embodiments, electrodes of the order of 10s of millimeters may be used and coatings of more than 600 micrograms or 1000 micrograms of polymer may be used to provide electrochemical sensors with a good response time.

In an embodiment using carbon paste electrodes containing ferrocene as the insensitive redox species 1123 and a polymer layer of polysulphone, an increased voltammetric response was found for pH levels 4, 7 and 9. These findings show the efficiency of the polymer layer in preventing diffusion of ferrocene into the solution since, without the polymer layer, the voltammetric response decreases as a function of time as the ferrocene ions escape into the solution.

A sensor using carbon paste electrodes containing anthraquinone with a polysulphone layer showed increased voltammetric response at pH 4 and 7. Without the polymer, an overall decrease in voltammetric response was found as the active species diffuse into the solution.

The carbon paste electrodes containing ferrocene and anthraquinone species with a polysulphone layer showed initial increase in oxidative waves for both species followed by a decrease at pH 4, fluctuations as pH 7 and an increase at pH 9. The anthraquinone peak is lost before the ferrocene peak suggesting the instability of the former species. In general, Applicants have found that use of a polymer layer over the electrode of the sensor system can prevent or limit diffusion of the redox species—anthraquinone, ferrocene or the like—from the sensor's electrode and by using the correct polymer layer properties still allow for interaction between the redox species and the fluid being tested. As such, a polymer coated electrochemical sensor may be used without causing contamination of the fluid, loss of the redox species and/or the like.

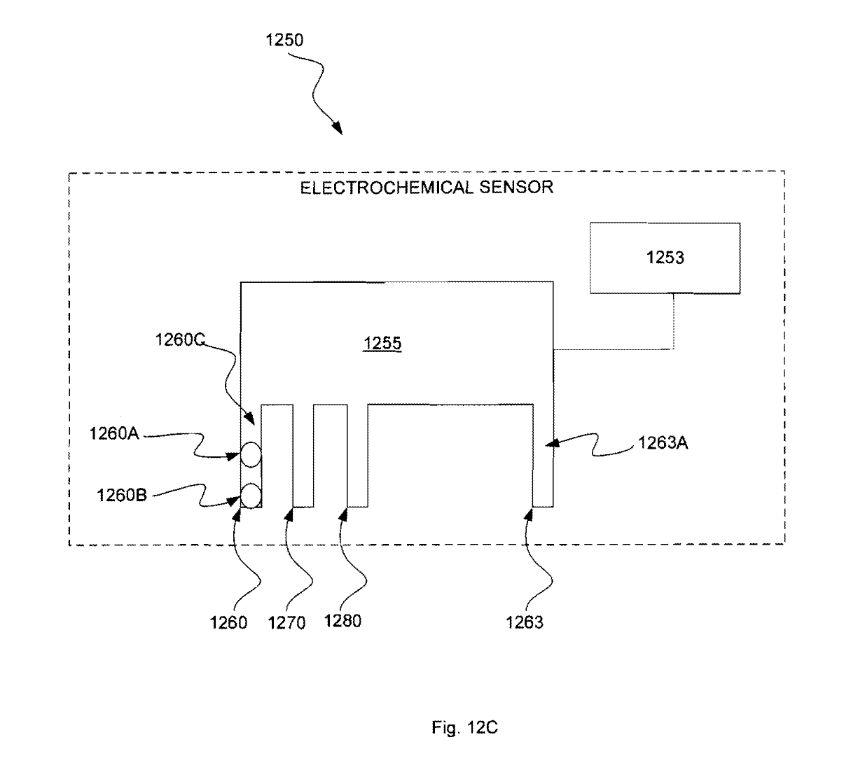

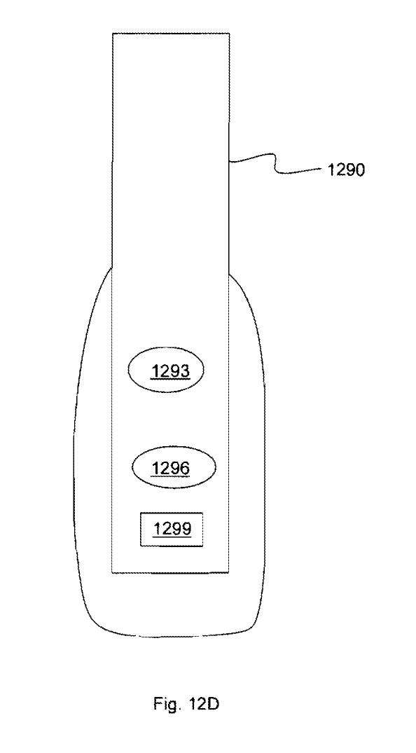

FIG. 12A illustrates erroneous results (peaks produced by active species other than the redox species of the system) from an electrochemical sensor in accordance with an embodiment of the present invention. FIG. 12A shows the square wave voltammetric response in the absence (dashed line) and presence of 0.5 mM ascorbic acid, catechol and sulfite (pH 7, phosphate buffer). In the presence of these interferences, new oxidation waves are observed at +0.45 V and +0.50 V for ascorbic acid and catechol, with a slight increase in the oxidative current recorded at 0.90 V in the case of sulfite. It can be seen that the presence of these interferences has no effect on the voltammetric signal of the pH active waves (Anthraquinone and Phenanthraquinone), with well defined waves observed. In the case of the ferrocene both catechol and ascorbic acid oxidize at potentials close to ferrocene and may serve to mask the ferrocene wave.

FIG. 12B shows a redox species for use in an embodiment of the present invention having an electron withdrawing or donating group added to the redox species. In one embodiment of the present invention, either electron withdrawing or donating groups are added onto/coupled with the redox species insensitive to the analyte. Merely by way of example, in one embodiment of the present invention, the insensitive redox species comprises a cyclopentadienyl ring of a ferrocene species, and electron withdrawing or donating groups are added to the cyclopentadienyl ring of the ferrocene species to either increase or decrease the redox potential of the ferrocene species, respectively. In this way, the electrochemical sensor may be configured such the activity of the ferrocene redox species is removed from the range where the majority of potential interferences occur.

In other embodiments, the redox species that is insensitive to the analyte, such as ruthenocene, may be used that have redox potentials outside of the potential range of the interferences. Similarly the redox species that is sensitive to the analyte can be manipulated to be removed from any potential interferences in an analogous manner.

In an embodiment of the present invention, the working electrode 1110 may comprise multiple different sensitive redox species. In such an embodiment, by choosing different sensitive redox species with discernable redox peaks, it is possible to create an electrochemical sensor that has a low susceptibility to noise from other active species of the like since at least one of the redox peaks associated with one of the sensitive redox species is discernable in a voltammogram or the like produced by such an electrochemical sensor.

FIG. 12C illustrates an electrochemical sensor in accordance with an embodiment of the present invention comprising one or more secondary working electrodes that do not include the redox species of the one or more primary working electrodes. In some embodiments of the present invention, the electrochemical sensor 1250 may comprise a primary working electrode 1260, a counter electrode 1270, a reference electrode 1280 and a secondary working electrode 1263.

In such embodiments, the active/primary working electrode 1260 may comprise a sensitive redox species 1260A on a conducting substrate 1260C. The secondary working electrode may comprise a conducting substrate 1263A absent the sensitive redox species 1260A. In certain aspects, the conducting substrate 1260C of the active/primary working electrode 1260 and the conducting substrate 1263A of the secondary working electrode 1263 may comprise the same conducting material. In some embodiments the dimension of the conducting substrate 1260C of the active/primary working electrode 1260 and the conducting substrate 1263A of the secondary working electrode 1263 may be identical.

To provide for the active/primary working electrode 1260 and the secondary working electrode 1263 seeing the same active contaminants (not shown) in the fluid being measured (not shown), the active/primary working electrode 1260 and the secondary working electrode 1263 may be disposed close to one another. Alternately, an agitator may be used to flow the fluid into contact with both the active/primary working electrode 1260 and the secondary working electrode 1263.

The active/primary working electrode 1260 and the secondary working electrode 1263 may be configured to interact with a similar amount of the fluid. In some embodiments, the counter electrode 1270 may be disposed between the active/primary working electrode 1260 and the secondary working electrode 1263. The secondary working electrode 1263 and the active/primary working electrode 1260 may be disposed symmetrically around the counter electrode 1270. The active/primary working electrode 1260 and the secondary working electrode 1263 may be disposed equidistant from the counter electrode 1270.

In some embodiment, the active/primary working electrode 1260 may incorporate both the redox species 1260A sensitive to the analyte to be detected/measured and a redox species that is insensitive to the analyte to be detected/measured 1260B on the surface of or coupled with the active working electrode 1260. In one embodiment of the present invention, however, the electrochemical sensor 1250 comprises a secondary working electrode 1263 that is not derivatised/coupled with any redox species. A measurement of a reduction/oxidation current and/or potential on the secondary working electrode 1263 will either by zero or have a value produced as a result of an active species being found in the solution/fluid being analyzed and/or in contact with the secondary sensing electrode 1263. As such, in one embodiment of the present invention a processor 1253 may process a resolved/corrected voltammogram for the electrochemical sensor 1250 by subtracting a voltammogram produced by the secondary working electrode 1263 from a voltammogram produced by the active/primary working electrode 1260.

While it has been found that simple subtraction of the two voltammograms or the data underlying said voltammograms may provide for attenuation/removal of electrochemical effects of active contaminants in the fluid being measured, the voltammogram for the secondary working electrode 1263 may be processed to identify peaks/troughs in the voltammogram. These peaks/troughs may then be mathematically described and the processor 1253 may then remove only the actual peaks/troughs found in the voltammogram from the secondary working electrode 1263 from the active/primary working electrode 1260.

In another aspect of the present invention, the electrochemical sensor 1250 comprises a secondary working electrode 1263 that is derivatised/coupled with an insensitive redox species. In either of these aspects, the secondary working electrode 1263 may be configured to have the same composition as the active working electrode 1260 and/or the same dimensions as the active working electrode 1260. In aspects of the present invention, the active/primary working electrode 1260 and the secondary working electrode 1263 may comprise the same insensitive redox species. In such aspects, reduction/oxidation peaks produced by the insensitive species may be used to coordinate the voltammogram from the active/primary working electrode 1260 with the voltammogram from the secondary working electrode 1263. For example, differences in the potential of the peaks, amplitude of the peaks in the two voltammograms may indicate a non-matching performance of the active/primary working electrode 1260 and the secondary working electrode 1263. When this occurs, new measurements may be taken by the electrochemical sensor 1250. Alternatively or additionally, the arrangement of the active/primary working electrode 1260 and the secondary working electrode 1263 may be changed, the difference between the peaks in the two voltammograms may be processed and used in the processing of the resolved voltammogram for the active/primary working electrode 1260 and/or the like.

In some embodiments of the present invention, the active/primary working electrode 1260 and/or the secondary working electrode 1263 may be coupled with two or more insensitive redox species. The two or more insensitive redox species may be selected with a known peak separation between reduction/oxidation peaks produced by the two insensitive redox species. This known peak separation may be used by the processor 1263 when it processes the measurement of the analyte from the resolved voltammogram. For example, the know separation can be used to identify reduction/oxidation peaks produced by the two insensitive redox species in the resolved voltammogram and these peaks may used as references with respect to a peak separation between the reduction/oxidation peaks of the sensitive redox species to the insensitive redox species from which the measurement of the analyte may be processed.

In an embodiment of the present invention where the electrochemical sensor comprises the active working electrode 1260 and the secondary working electrode 1263—voltammetry of the two working electrodes may be recorded/processed; where this voltammetry comprises both the response of the redox species 1260A & B on the active working electrode 1260 and the redox active interferences from redox species in the fluid as provided by a voltammogram from the secondary working electrode 1263. In such an embodiment, the voltammetry of the secondary working electrode 1263 may be subtracted from the voltammetry of the active working electrode 1260 to produce a signal which only incorporates the signals from the redox species 1260A & B on the active working electrode 1260, without the contribution/interferences of any active species/redox species in the fluid to be analyzed allowing the electrochemical sensor to work in these ‘hostile’ environments. By configuring the composition and/or dimensions of the secondary working electrode 1263 to minor that of the active working electrode 1260, with the exception of redox species sensitive to the analyte to be detected/measured 1260A, the active species or the like in the fluid may produce equivalent effects at both the active working electrode 1260 and the secondary working electrode 1263.

FIG. 12D illustrates an electrochemical sensor in accordance with an embodiment of the present invention in which the active/primary working electrode comprises at least a first and a second redox species that are both insensitive to an analyte, where a peak-to-peak separation of the voltammetric responses of two insensitive redox species is known. In FIG. 12D, a first working electrode 1290 is coupled with a first redox species 1293 and a second redox species 1296; where the first and the second redox species 1293, 1296 are both insensitive to the analyte to be measured. The first redox species 1293 produces a peak-redox-voltage, that is independent of the presence of the analyte at a first potential and the second redox species 1296 produces a second peak-redox-voltage, that is independent of the presence of the analyte at a second potential; and the difference in the first and second potentials is known. In such a configuration, the peak-to-peak separation remains the same regardless of the presence of the analyte and is essentially a constant feature of the electrochemical sensor under operating conditions.

In certain aspects, the difference in location on the voltammogram of the first and second potentials is selected to lessen any overlap in the two peaks. Additionally, in certain aspects of the present invention, the first redox species 1293 and the second redox species 1296 may be coupled with separate working electrodes (not shown), which may provide, among other things, for ease of manufacture, efficient operation of the electrochemical sensor, improved signal processing and/or the like.

In some aspects, manipulation of the configuration of the insensitive redox species may be performed to provide for producing at least two redox species that are insensitive to the analyte to be detected but that produce separate voltammetric peaks in the presence of the analyte. For example, this response separation may be produced by using different functional groups on the cyclopentadienyl ring of the ferrocene.

In other embodiments, two different redox species that are insensitive to the same analyte may be chosen that produce different voltammetric response peaks under application of a potential. In both embodiments, the electrochemical sensor comprises at least two pairs of redox active species that are insensitive to the analyte with a defined peak-to-peak separation, which peak-to-peak separation is independent of the pH of the solution being tested, any other species in the solution and/or the like.

In an embodiment of the present invention, the electrochemical sensor including the sensing electrode(s) comprising at least a first and a second redox species that are both insensitive to analyte, further comprises a sensitive redox species 1299 that is sensitive to the analyte to be measured. The sensitive redox species 1299 may be coupled with the active/primary working electrode 1290. In other aspects, the sensitive redox species 1299 may be coupled with a second active/primary working electrode (not shown). Among other things, for ease of manufacture, cost, effective operation of the electrochemical sensor and or the like, the active/primary working electrode 1290 may comprise a polymer layer 1297. The sensitive redox species 1299 produces a peak in the voltammetric response that has a different location depending upon the amount/presence of the analyte to be measured.

In accordance with an embodiment of the present invention, the voltammetric output from the sensor may be processed using a processor, software and/or the like to provide that peaks from the redox active species insensitive to the analyte can be detected based upon/using the known peak-to-peak separation of the at least two active insensitive redox species. In this way, the location of the reference peaks produced by the first redox species 1293 and the second redox species 1296 may be processed even in the presence of noise, interference or the like. At least one of the reference peaks may then be processed along with the location of the peak produced by the sensitive redox species 1299 to obtain a measurement of the analyte. In some aspects, the peaks produced by the first redox species 1293 and the second redox species 1296 may be used to identify the peak from the sensitive redox species 1299. Using an electrochemical sensor comprising first redox species 1293 and the second redox species 1296 having a know peak-to-peak separation, an electrochemical sensor in accordance with an embodiment of the present invention may be used to detect the analyte even in the presence of interference from other active species in the analyte.

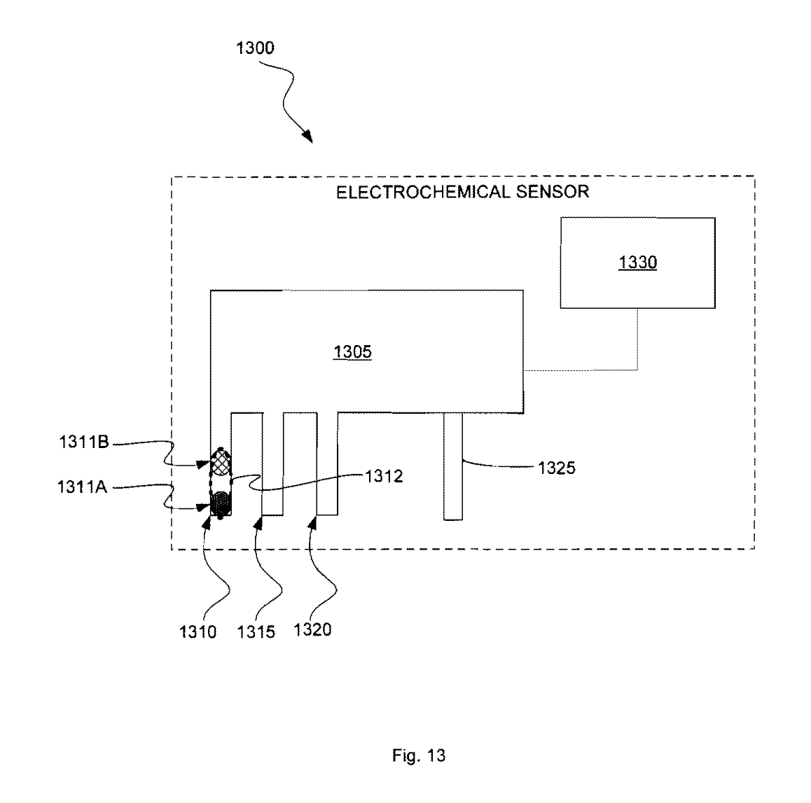

FIG. 13 is a schematic-type illustration of an electrochemical sensing system in accordance with an embodiment of the present invention. As depicted the electrochemical sensing system 1300 comprises an electrical hardware system 1305. The electrical hardware system 1305 is coupled with one or more electrodes for contacting with a fluid (not shown) to detect/measure a certain analyte.

In some embodiments, the electrodes are contacted directly with a fluid to be analyzed. In other embodiments, the electrodes are contacted with a selected fluid and the fluid to be analyzed may be contacted with a membrane and the analyte to be detected/measured may diffuse through the membrane from the fluid to be analyzed to the selected fluid and it may then be detected/measured by the electrochemical sensor 1300 via the electrodes. In one embodiment of the present invention the electrical hardware system 1305 is electrically coupled with an active/primary working electrode 1310, a counter electrode 1315, a reference electrode 1320 and a secondary working electrode 1325.

The electrical hardware system 1305 may comprise a power supply, voltage supply, potentiostat and/or the like for applying an electrical potential to the working electrode 1310, a detector—such as a voltmeter, a potentiometer, a potentiostat, an oscilloscope, an ammeter, resistometer and/or the like—for measuring: (a) a potential between the active/primary working electrode 1310 and the counter electrode 1315 and/or the reference electrode 1320; (b) a potential between the secondary working electrode 1325 and the counter electrode 1315 and/or the reference electrode 1320; (c) a current flowing between the active/primary working electrode 1310 and the counter electrode 1315 (where the current flow will change as a result of the oxidation/reduction of a sensitive redox species 1311A and/or an insensitive redox species 1311B); and/or (d) a current flowing between the secondary working electrode 1325 and the counter electrode 1315 (where the current flow will change as a result of reduction/oxidation of active contaminants in the fluid being analyzed). The electrical hardware system 1305 also comprises circuitry for electronically coupling the voltage supply or the like, the active/primary working electrode 1310, the secondary working electrode 1325, the counter electrode 1315, the reference electrode 1320 and the detector.

In an embodiment of the present invention the electrical hardware system 1305 may sweep a voltage difference across the electrodes and as such the hardware system 1305 may comprise hardware configured for voltammetry so that, for example, linear sweep voltammetry, square wave voltammetry and/or the like may be used to obtain measurements of the analyte using the electrochemical sensor. The electrical hardware system 1305 may include signal processing electronics and the like.

In some embodiments of the present invention, the electrochemical sensing system 1300 comprises at least the active/primary working electrode 1310, the secondary working electrode 1325, the counter electrode 1315 and the reference electrode 1320. Such embodiments allow for the use of electrodes that are larger in size than microelectrodes. For example in some embodiments of the present invention the working electrodes may be larger than 1 micro-meter in dimension. In other embodiments the working electrodes may be of the order of 10s of micro-meters or 100s of micrometers in dimension. In yet other embodiments the working electrodes may be of the order of millimeters, 10s of millimeters, centimeters or larger in dimension. Using an electrode that is larger than a microelectrode may reduce/prevent fouling of the electrode or the like.

In one embodiment of the present invention, the secondary working electrode 1325 is coupled with the sensitive redox species 1311A. In certain aspects, the sensitive redox species 1311A comprises a redox species that is sensitive to an analyte to be detected, monitored, measured and/or the like. In an embodiment of the present invention, the insensitive redox species 1311B is coupled with the secondary working electrode 1325. In certain aspects, the insensitive redox species 1311B comprises a redox species that is insensitive to an analyte to be detected, monitored, measured and/or the like.

The area(s) of the secondary working electrode 1325 comprising the sensitive redox species 1311A and the insensitive redox species 1311B may be considered as an active area(s) 1312 of the secondary working electrode 1325. The active area 1312 may be contacted with a fluid to detect/measure the presence of an analyte of interest. In certain aspects, the active area may be covered with a polymer layer/coating or the like to separate the sensitive redox species 1311A and/or the insensitive redox species 1311B from the fluid. In some aspects, the active area 1312 may comprise areas/sections of the working electrode 1310 that are not coupled with the sensitive redox species 1311A and/or the insensitive redox species 1311B.

In an embodiment of the present invention, a voltammetric measurement is made between the active/primary working electrode 1310, the counter electrode 1315 and/or the reference electrode 1320 and a voltammetric measurement is made between the secondary working electrode 1324, the counter electrode 1315 and/or the reference electrode 1320. The voltammetric measurements may comprise a current flowing between the working electrodes and the counter electrode 1315, a potential difference between the working electrodes and the counter electrode 1315 and/or a potential difference between the working electrodes and the reference electrode 1320. Such a voltammetric measurement may in some aspects comprise a voltammogram, a square wave volytammogram and or the like. In one embodiment of the present invention, the voltametric response of the electrochemical sensing system 1300 in the presence of an analyte may be output to a processor 1330 for processing.

The reference electrode 1320 may provide the potential against which the potential of the working electrode is compared. This buffering against potential changes is achieved by the electrode containing a constant composition of both forms of its redox couple. In an ideal case the reference potential would be independent of sample composition as the electrode itself is isolated from the sample species through an intermediate bridge. However, this cannot always be achieved as factors such as electrode arrangement, cost etc. have to be considered and hence the reference electrode potential may drift or vary from sample to sample. Because of this drift, among other reasons, in an embodiment of the present invention, the non-sensitive redox species 1311B may be coupled with the active/primary working electrode 1310 to provide a reference. In some embodiments of the present invention the reference electrode may comprise silver, silver-chloride and/or the like. In aspects of the present invention the reference electrode is contacted with the fluid.

The processor 1330 may take a voltammogram or the data underlying such voltammogram from the active/primary working electrode 1310 and a voltammogram or the data underlying such voltammogram from the secondary working electrode 1325. The processor may process the two voltamograms to produce a resolved voltammogram or the data underlying such a resolved voltammogram. The processor 1330 may then process the resolved voltammetric response of the active/primary working electrode 1310 to determine the existence of peaks in the response characteristic of oxidation/reduction of the sensitive redox species 1311A by the analyte to be detected. As discussed above, in some aspects of the present invention, the insensitive redox species 1311B may comprise two or more redox species insensitive to the analyte with a known/defined peak-to-peak separation, where the known peak-to-peak separation is the separation of oxidation/reduction peaks on the voltammogram corresponding to the two insensitive redox species. In such aspects, the processor 1330 may use the peak-to-peak separation to determine/process the presence of the characteristic peaks of the sensitive redox species 1311A in the presence of the analyte to be detected. For example, such use of the known/defined peak-to-peak separation may provide for detecting/processing the characteristic peaks of the sensitive redox species 1311A in the presence of the analyte to be detected when there are reactive species in the fluid being measured/monitored causing noise in the voltammetric measurements.

By knowing the peak-to-peak separation of the different insensitive redox species it is easier for the processor to pick out peaks associated with the insensitive redox species from the background noise, where these peaks are the reference against which the peak from the sensitive redox species are measured. In certain aspects, while two insensitive redox species are used, the measurement of the analyte is processed by the processor 1330 using at least one of these peaks and in addition an output from the reference electrode 1320, where the output from the reference electrode 1320 may provide for obtaining a scale for the voltammetric response of the electrochemical sensor, removing drift and/or the like.

In some embodiments of the present invention, the electrochemical sensing system 1300 may not have a uniform response/sensitivity across all concentrations of the analyte to be detected. For example, the electrochemical sensing system 1300 may not have a uniform response across all pH values. For example, the sensitivity of the electrochemical sensor may change abruptly at a certain concentration of the analyte. For example, in the case of a pH sensor, the threshold measurement of the hydrogen ion concentration comprises of two sensitivity regions, in which the threshold value between the two sensitivity regions is dependent on the pKa of the sensitive species.

Such a change may be dependent upon the sensitive redox species used and a threshold value for the change(s) in sensitivity may be determined by theory, modeling, experiment, operation of the sensor in known conditions and/or the like. As such, the processor 1330 may certain aspects of the present invention be configured to recalibrate the electrochemical sensing system 1300 at one or more threshold concentrations of the analyte to be detected. For example, the processor 1330 may recalibrate the electrochemical sensing system 1300 for detection/measurement of high pH values and/or low pH values.

The processor 1330 may process the resolved voltammetric response of the active/primary working electrode 1310 to determine the existence of peaks in the response characteristic of oxidation/reduction of the sensitive redox species 1311A, where the peaks are perturbed by the analyte to be detected. In certain embodiments of the present invention, the processor 1330 may process the resolved voltammetric response to determine the existence of peaks in the response characteristic of oxidation/reduction of the insensitive redox species 1311B, unlike the sensitive redox species 1311A, the peaks produced by the insensitive redox species 1311B are not affected by the presence of the analyte. In an embodiment of the present invention, the output peaks from the sensitive redox species 1311A and the insensitive redox species 1311B may be combined and used by the processor to process a measurement of the analyte.

In certain embodiments of the present invention, the insensitive redox species 1311B may comprise a redox species that is sensitive to the analyte to be detected. As such, the electrochemical sensor will comprise at least two sensitive redox species. In such embodiments, the output from the sensitive redox species 1311A and the insensitive redox species 1311B may be combined and used by the processor to process a measurement of the analyte.

In some embodiments of the present invention, the electrochemical sensing system 1300 may comprise a temperature probe (not shown). In certain aspects, the response of the sensitive redox species 1311A to the analyte to be detected and/or the oxidation/reduction characteristics of the insensitive redox species 1311B may be temperature dependant. As such, in an embodiment of the present invention, the temperature of the fluid being tested may be measured by the temperature probe and communicated to the processor 1330. The processor 1330 may use the temperature to process the detection/measurement of the analyte to be detected from the voltammetric output of the electrochemical sensing system 1300. For example, the processor may calibrate the voltammetric output from the electrochemical sensor 1300 based upon a temperature measurement from the temperature probe.

In certain aspects of the present invention, the sensitive redox species 1311A and insensitive redox species 1311B may be coupled with different active working electrodes. In some aspects, the active/primary working electrode 1310 may comprise an array of active working electrodes. In an embodiment of the present invention, the area of the counter electrode 1315 is of the same order as the area of the active/primary working electrode 1310. In other embodiments, the area of the counter electrode 1315 is less than a hundred (100) times the area of the active/primary working electrode 1310. In other embodiments the area of the counter electrode 1315 is of the order of between 1 and 90 times the area of the active/primary working electrode 1310.

In some embodiments of the present invention, at least the active/primary working electrode 1310 may be contacted with the fluid to be tested. As discussed above, in some aspects a polymer layer may be deposited over the active/primary working electrode 1310 to prevent the sensitive redox species 1311A and/or the insensitive redox species 1311B diffusing, leeching and/or the like into the fluid being tested. In other aspects, the fluid to be tested is contacted with a membrane that allows for a flow of the analyte to be detected or measured through the membrane into a fluid in contact with at least the active/primary working electrode 1310. In this way, the electrochemical sensing system 1300 may be protected from any detrimental properties of the fluid being tested. In embodiments where the active/primary working electrode 1310 is covered with a polymer layer, the secondary working electrode 1325 may also be covered with such a polymer layer.

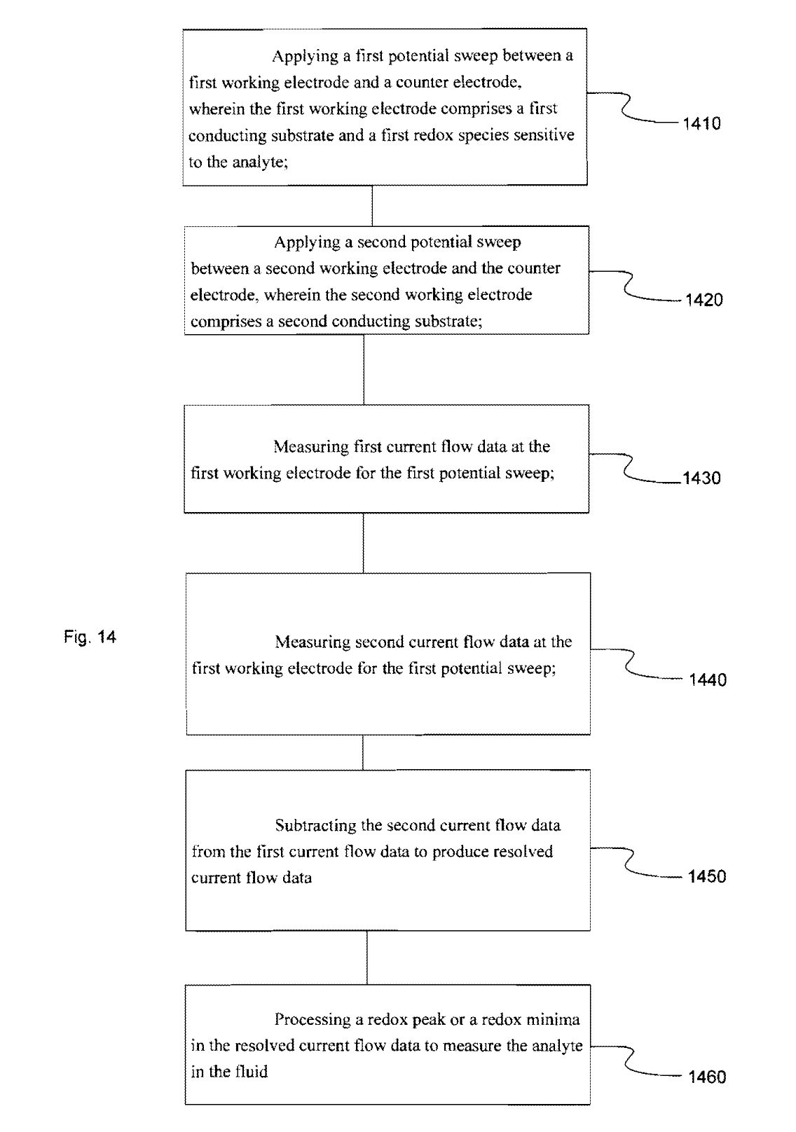

FIG. 14 is a flow-type description of a method of using an electrochemical sensor to measure an analyte in a fluid in accordance with the present invention. In 1410, a potential sweep is applied between a first working electrode comprising a sensitive redox species sensitive to the analyte to be measured and a counter electrode. In 1420 a second potential sweep is applied between a second working electrode that comprises a conducting substrate absent the sensitive redox species and the counter electrode. The first and the second potential sweeps may comprise the same potential sweep with both the first and the second working electrodes being coupled to the same potential sweep generator, such as a poteniostat or the like. In a potentiostat a reference electrode is used to automatically control the cell potential. A potentiostat measures the potential difference between the working and the reference electrode, applies the current through the counter electrode and measures the current as an i R voltage drop over a series resistor. As such, in 1410 and 1420, the potential sweep may be provided by applying a sweeping current to the counter electrode.

In 1430, current flow data may be measured at the first working electrode for the first potential sweep. This current flow measurement may comprise measuring the current flowing between the first working electrode and the counter electrode, a potential difference between the first working electrode and the counter electrode and/or the reference electrode and/or the like. In 1440 current flow data may be measured at the second working electrode for the second potential sweep. This current flow measurement may comprise measuring the current flowing between the second working electrode and the counter electrode, a potential difference between the second working electrode and the counter electrode and/or the reference electrode and/or the like.

In 1450, the second current flow data is subtracted from the first current flow data to produce resolved current flow data. While such subtraction may be expected to result in useless data because of noise etc. associated with the measured current flow data, Applicants have found that the resulting resolved current flow data can be interpreted. In some embodiments, peaks/troughs in the current flow data from the second working electrode may be identified and mathematically approximated/modeled. These peaks may then be removed from the current flow data from the first working electrode to provide the resolved current flow data. This peak/trough removal may result in a more accurate/understandable resolved current flow data voltammogram.

In 1460, as has been discussed above, processing of the reduction/oxidation peaks in the resolved current flow data may provide for measuring the analyte in the fluid. In some embodiments, the first working electrode may comprise only one redox species sensitive to the analyte and the peaks produced by this redox species may be compared to a reference signal from the reference electrode. In other embodiments, the first working electrode may comprise two or more different redox species sensitive to the analyte and the peaks produced by these redox species may be compared to a reference signal from the reference electrode. In some embodiments, the first working electrode may comprise one or more redox species sensitive to the analyte and one or more redox species insensitive to the analyte and the reduction oxidation peaks from the various redox species may be processed in the resolved current flow data to measure the analyte.

Various embodiments and applications of the invention have been described. The descriptions are intended to be illustrative of the present invention. It will be apparent to those skilled in the art that modifications may be made to the invention as described without departing from the scope of the claims set out below.

1. An electrochemical sensor for measuring an analyte in a fluid, comprising:
a first working electrode comprising a conducting substrate and a first set of redox species sensitive to the analyte;
a second working electrode comprising a second conducting substrate;
a counter electrode; and
a reference electrode.

2. The electrochemical sensor of claim 1, further comprising:
means for applying a potential sweep between the first working electrode and the reference electrode;
means for measuring a first current at the first working electrode;
means for applying a potential sweep between the second working electrode and the counter electrode;
means for measuring a second current at the second working electrode; and
a processor configured to process a measurement of the analyte from the first and the second currents and the applied potential sweep.

3. The electrochemical sensor of claim 2, wherein the processor is configured to process the measurement of the analyte from peaks in the first current.

4. The electrochemical sensor of claim 2, wherein the processor processes the measurement of the analyte by subtracting the second current from the first current to obtain a resolved current and processes the measurement of the analyte from peaks in the resolved current.

5. The electrochemical sensor of claim 1, wherein the first and the second conducting substrate comprise the same material.

6. The electrochemical sensor of claim 1, wherein the first and the second conducting substrates have the same dimensions.

7. The electrochemical sensor of claim 1, wherein the first and the second working electrodes are disposed symmetrically around the counter electrode.

8. The electrochemical sensor of claim 1, wherein the first and the second working electrodes are at least partially covered with a polymer coating.

9. The electrochemical sensor of claim 2, wherein the first working electrode further comprises a second set of redox species insensitive to the analyte.

10. The electrochemical sensor of claim 9, wherein the first working electrode further comprises a third set of redox species insensitive to the analyte and wherein a separation between a first redox peak for the first set of redox species and a second redox peak for the third set of redox species is known.

11. The electrochemical sensor of claim 2, wherein the first working electrode and the second working electrode further comprises a third set of redox species insensitive to the analyte.

12. The electrochemical sensor of claim 11, wherein a third redox peak produced by the third redox species is used to resolve a first voltammogram for the first working electrode with a second voltammogram from the second working electrode.

13. The electrochemical sensor of claim 2, wherein at least one of the means for applying the potential sweep between the first working electrode and the reference electrode and the means for applying the potential sweep between the second working electrode and the reference electrode comprises a potentiostat.

14. The electrochemical sensor of claim 2, wherein the means for applying the potential sweep between the first working electrode and the reference electrode and the means for applying the potential sweep between the second working electrode and the reference electrode comprises a potentiostat comprises the same potentiostat.

15. The electrochemical sensor of claim 2, wherein the means for measuring the first current at the first working electrode and the second current at the second working electrode comprises an ammeter.

16. The electrochemical sensor of claim 2, wherein the means for measuring the first current at the first working electrode and the second current at the second working electrode comprises a potentiostat.

17. The electrochemical sensor of claim 2, wherein the first working electrode and the second working electrode are cross-wired such that in use the first electrode and the second electrode are provided with the same potential sweep.

18. The electrochemical sensor of claim 2, wherein the potential sweep and the second potential sweep comprise square wave potential sweeps.

19. A working electrode for use in an electrochemical sensor according to claim 1, comprising:
the first conducting substrate;
the first redox species coupled with the conducting substrate, wherein the first conducting substrate comprises a conducting material identical to the second conducting substrate.

20. A method for operating an electrochemical sensor for measuring an analyte in a fluid, comprising:
applying a first potential sweep between a first working electrode and a counter electrode, wherein the first working electrode comprises a first conducting substrate and a first redox species sensitive to the analyte;
applying a second potential sweep between a second working electrode and the counter electrode, wherein the second working electrode comprises a second conducting substrate;
measuring first current flow data at the first working electrode for the first potential sweep;
measuring second current flow data at the second working electrode for the second potential sweep;
subtracting the second current flow data from the first current flow data to produce resolved current flow data;
processing a redox peak or a redox minima in the resolved current flow data to measure the analyte in the fluid.

21. The method of claim 20, wherein:
the first working electrode comprises a second redox species that is insensitive to the analyte; and
the step of processing the redox peak or the redox minima in the resolved current flow data to measure the analyte in the fluid comprises processing a separation between a first redox peak or minima in the resolved current flow data produced by the first redox species and a second redox peak or minim in the resolved current flow data produced by the second redox species.

22. The method of claim 20, wherein the first working electrode comprises two cross wired electrodes, and wherein the first of the cross-wired electrodes comprises the conducting substrate and the first redox species and the second cross-wired electrode comprises the substrate and the second redox species.

23. The method of claim 20, further comprising:
cross-wiring the first and the second working electrodes.

24. The method of claim 20, further comprising:
sweeping the first and the second potential sweeps from a first potential lower than a potential producing a redox peak for the first redox species to a first potential higher than a potential producing the redox peak for the first redox species;
sweeping the first and the second potential sweeps from a second potential higher than the potential producing a redox peak for the first redox species to a second potential lower than the potential producing the redox peak for the first redox species;
averaging the first current flow data for the first working electrode produced by the two sweeps;
averaging the second current flow data for the second working electrode produced by the two sweeps; and
using the averaged first current flow data and the averaged second current flow data in the step of subtracting the second current flow data from the first current flow data to produce resolved current flow data.

25. The method of claim 20, further comprising:
using a reference electrode.

26. The method of claim 20, wherein the first and the second conducting substrates are the same.

27. The method of claim 20, wherein the dimensions of the first and the second conducting substrates are the same.

28. The method of claim 20, wherein the first working electrode comprises a second redox species that is insensitive to the analyte.

29. The method of claim 20, wherein the step of processing the redox peak or the redox minima in the resolved current flow data to measure the analyte in the fluid comprises processing a separation of a first redox peak or a first redox minima produced by the first redox species in the resolved current data and a second redox peak or a second redox minima produced by the second redox species in the resolved current data.

30. The method of claim 20, wherein the first and the second working electrode each comprise a second redox species that is insensitive to the analyte, and wherein a rexo peak and or minima produced by the second redox species is used to coordinate the first current flow data and the second current flow data.

31. The method of claim 20, further comprising:
producing a mathematical description of one or more peaks in the second current flow data produced by active contaminants in the fluid; and
using the mathematical description in the step of subtracting the second current flow data from the first current flow data to produce the resolved current flow data.

32. The method of claim 20, wherein the first and second working electrode are disposed equidistant from the counter electrode.

33. The method of claim 20, wherein the counter electrode is disposed between the first and second working electrodes.
